(19) United States
(12) Patent Application Publication
(10) Pub. No.: US 2010/0271409 A1
(43) Pub. Date: Oct. 28, 2010

(54) IMAGE DISPLAY APPARATUS, COLOR SIGNAL CORRECTION APPARATUS, AND COLOR SIGNAL CORRECTION METHOD

(76) Inventors: Hiroyasu Makino, Osaka (JP); Katsumi Adachi, Nara (JP); Seiji Minami, Hyogo (JP); Hideki Nakata, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/809,230

(22) PCT Filed: Oct. 20, 2009
(86) PCT No.: PCT/JP2009/005492

§ 371 Date: Jun. 18, 2010

(30) Foreign Application Priority Data
Oct. 20, 2008 (JP) 2008-269421
Jun. 4, 2009 (JP) 2009-135497

(51) Int. Cl. G09G 5/10

(52) U.S. Cl. 345/690

(57) ABSTRACT

Upon displaying an image using the subfield driving method, a luminance discrepancy or a chromaticity discrepancy is reduced while effects of horizontal crosstalk are reduced.

An image display apparatus (50) that displays an image using the subfield driving method includes: an SF conversion unit (52) which (i) obtains a lighting pattern associated with a luminance indicated by an input color signal of each of red, green, and blue colors, with reference to an SF conversion table in which a lighting pattern indicating which subfield requires lighting among subfields is stored in association with a luminance indicated by a color signal of each of the colors, and (ii) generates for each of the colors, a lighting signal according to the obtained lighting pattern; and a PDP module (53) which displays the image by causing luminescent materials to produce luminescence according to the lighting signal, wherein the number of variations of the lighting pattern stored in at least one of the SF conversion table for blue and the SF conversion table for red is larger than the number of variations of the lighting pattern stored in the SF conversion table for green.

### TECHNICAL FIELD

The present invention relates to an image display apparatus which displays images on a display unit such as a plasma display panel (abbreviated as PDP) using a subfield driving method, and to a color signal correction apparatus and a color signal correction method which are applied to the image display apparatus.

### BACKGROUND ART

The PDPs are roughly classified into two types: AC type and DC type in terms of driving, and surface-discharging type and opposite-discharging type in terms of discharging. Among those PDPs, a PDP of surface-discharging type with a three-electrode structure is currently predominant because the PDP is capable of providing images with higher definitions on a larger screen and moreover is easy to manufacture.

In this surface-discharging panel, a pair of substrates of which at least a front substrate is transparent is provided so as to face each other to form a discharge space therebetween. These substrates are provided with barrier walls which divide the discharge space into multiple sections. Furthermore, electrode groups are arranged on the substrates such that discharge can take place in each section of the discharge space formed by the barrier walls. Then, phosphors each of which emits red, green, or blue light when excited by the discharge are provided to form discharge cells. Such a surface-discharging panel uses vacuum ultraviolet radiation having a short wavelength, which is generated by the discharge, to excite the phosphors so that red, green, and blue discharge cells emits visible red, green, and blue light, respectively, to display color images. Among flat panel displays, this PDP has in particular gathered recent attention for such reasons as the capability of high-speed display, a wide viewing angle, ease of increase in size, high display quality which is because the PDP is self-emissive. The PDP has therefore been used in various applications as a display device for use in a place where many people gather or as a large-screen display device at home.

As a method of driving the PDP structured as above, there is a method in which a lighting time is temporally divided as shown in FIG. 18, that is, one filed period is divided into multiple subfields (which may be hereinafter referred to as “SF”), and by combination of the lighting subfields, each of the red, green, and blue (RGB) cells represents a gradation level. Each of the subfields has a reset period, a write period, and a sustain period. In this reset period, a reset discharge is produced to form wall charges necessary for the following write operation. In the write period, the wall charges are formed by selective production of write discharges in the discharge cells according to an image to be displayed. Subsequently, in the sustain period, sustain pulses are applied alternately to a scanning electrode and a sustain electrode, which form a pair of display electrodes, to produce a sustain discharge and thereby cause the phosphor in the corresponding discharge cell to produce luminescence, with the result that an image is displayed. FIG. 18 is an example with eight SFs.

[Citation List]

[Patent Literature]

[PTL 1]

Japanese Unexamined Patent Application Publication 2003-131580

### SUMMARY OF INVENTION

### Technical Problem

In order to represent a color at the gradation levels by using SFs, the PDP gives weights of 1, 2, 4, 6, 12, and the like to the sustain pulses for the SFs and illuminates pixels in the SFs of which combination is associated with an entered gradation level. FIG. 19 shows an example with eight SFs and the maximum gradation level of 135, in which a blank indicates non-lighting and “1” indicates lighting.

The conventional PDP has a problem that when the non-lighting continues across the SFs, the discharge cell may not light up due to a phenomenon called horizontal crosstalk. Specifically, the gradation level “4”, for example, shown in FIG. 20 is represented by sequential non-lighting through SF1 and SF2 followed by lighting in SF3. In such a case, a lighting failure is likely to occur in the SF3.

Now, the horizontal crosstalk phenomenon is described in detail. The barrier walls, which separate the discharge cells of the PDP, have in practice a gap of several μm between the front substrate and the rear substrate. To reproduce mixed colors, the discharges from adjacent discharge cells will therefore interfere with each other as shown in FIG. 21. Such a phenomenon is called “horizontal crosstalk” (or “horizontal XT”).

Effects of the horizontal crosstalk phenomenon will be described in detail. The PDP selects lighting or non-lighting in SF by producing a write discharge. For example, when write discharges are produced in the red (R), green (G), and blue (B) discharge cells at the same time, priming particles jump from the R and B discharge cells into the G discharge cell, which makes the G discharge cell more likely to produce a write discharge (light up). In contrast, when the R, G, and B discharge cells light up in the respective SFs as shown in FIG. 22, the wall discharges accumulating in the G discharge cell are deprived in SF3 by the priming particles from the R and B discharge cells, which likely causes a writing failure (lighting failure) in the G discharge cell in the following SF4. Thus, the horizontal crosstalk may make it difficult to control the lighting and non-lighting.

A discharge cell affected most by the horizontal crosstalk is the G discharge cell while the R and B discharge cells are not so affected by the horizontal crosstalk. This is because G is high in visibility and therefore becomes visually prominent when a lighting failure occurs. In addition, not only the visual aspect but also a phosphor material for G is a reason for such susceptibility because a surface of the phosphor for G is charged to a polarity (negative) which is different from a polarity to which phosphor materials of R and B are charged, and the R and B discharge cells therefore bring wall discharges in the G discharge cell into the susceptible state.

In order to avoid problems caused by the horizontal crosstalk, the conventional PDPs reproduce a color at a desired gradation level using a method (e.g., dithering or error diffusion) in which among the gradation levels shown in FIG. 19, gradation levels (e.g., as shown in FIG. 23) which are other than the gradation levels realized by SFs including sequential no-lighting SFs as those indicated in shades in FIG. 20 are temporally or spatially combined. Specifically, to reproduce a color at the gradation level “4”, for example, colors at the gradation levels “3” and “5” are represented alternately in time or in space.

In the PDP structured as above, in order to adjust gradation characteristics, a luminance for an entered gradation level is measured for each of R, G, and B to adjust a look-up table (LUT) for each of R, G, and B and make corrections on light-emission luminance characteristics.

By the way, in recent years, there has been a growing demand for large-screen PDPs with improved image quality as professional devices (such as master monitors and post-production monitors). There are various standards for certifying the professional devices. For example, one of the standards is such that upon displaying white having a color temperature of 5,600K, chromaticity discrepancies (differences between target chromaticity and measured chromaticity) at 50th or higher gradation levels among 255 entered gradation levels needs to be within plus/minus 0.002. When the PDP lights up with R, G, and B having the same SF pattern, white having a color temperature of 9,000K is displayed. In the case where the PDP thus displays white having a color temperature of 9,000K, the chromaticity discrepancy is within an allowable range as shown in FIG. 24.

However, a decrease in luminance of B for lowering the color temperature to 5,600K will make the chromaticity at a middle gradation level to a high gradation level oscillate as shown in FIG. 25, resulting in the chromaticity out of the allowable range.

This is because lighting for mixed colors becomes more likely than lighting for a single color due to the horizontal crosstalk. To be specific, in the PDP, the LUT is used to control a relation between an entered luminance and an output luminance for each single color of R, G, and B, but in the case of representing mixed colors, the discharge cells become more likely to produce discharges, which makes the luminance too high as compared to the case of representing a single color (in this regard, it can be said that the PDP does not, in a narrow sense, provide the additive color mixing).

In detail, for the white having a color temperature of 9,000K, luminance discrepancies (differences between required luminance values and measured luminance values) are generated at a middle gradation level to a high gradation level, but the luminance discrepancies for R, G, and B are in balance as shown in FIG. 24, resulting in no chromaticity discrepancies. On the other hand, for the white having a color temperature of 5,600K, the lighting state in the SFs for the entered gradation level is different between B and RG, which disrupts the balance of the luminance discrepancies between B and RG, resulting in the chromaticity discrepancies.

The chromaticity discrepancy of white is distinct and as shown in FIG. 25, the current chromaticity discrepancies expand as wide as the range of plus/minus 0.003, leading to a problem that the PDPs are not able to be used as post-production monitors.

The present invention has been made in view of the above situation, and an object of the present invention is to provide an image display apparatus and a color signal correction apparatus which enable a significant reduction of at least one of a luminance discrepancy and a chromaticity discrepancy while reducing effects of horizontal crosstalk when displaying an image using the subfield driving method.

### Solution to Problem

In order to achieve the above object, the image display apparatus according to an aspect of the present invention is an image display apparatus that displays an image by causing pixels to produce luminescence according to color signals of red, green, and blue colors using a subfield driving method, the pixels each including luminescent materials of red, green, and blue colors, the image display apparatus including: an SF conversion table storage unit configured to store, for each of the colors, an SF conversion table in which a lighting pattern indicating which subfield requires lighting among subfields is stored in association with a luminance indicated by a color signal of each of red, green, and blue colors; an SF conversion unit configured to (i) obtain the lighting pattern associated with the luminance indicated by the input color signal of each of the colors, with reference to the SF conversion table for each of the colors stored in the SF conversion table storage unit, and (ii) generate, for each of the colors, a lighting signal according to the obtained lighting pattern; and an image display unit configured to display the image by causing the luminescent materials to produce luminescence according to the lighting signal generated by the SF conversion unit, wherein the number of variations of the lighting pattern stored in at least one of the SF conversion table for blue and the SF conversion table for red is larger than the number of variations of the lighting pattern stored in the SF conversion table for green.

This allows the number of variations of the lighting pattern for at least one of the blue and red colors, which are less susceptible to the horizontal crosstalk, to be larger than the number of variations of the lighting pattern for a green color, which is susceptible to the horizontal crosstalk, with the result that it becomes possible to increase the number of representable gradation levels while reducing occurrences of the horizontal crosstalk. Accordingly, a luminance discrepancy and a chromaticity discrepancy at a middle gradation level can be reduced effectively. Furthermore, the increase in the number of representable gradation levels allows a luminance discrepancy and a chromaticity discrepancy of white to be reduced as well.

Furthermore, it is preferable that the lighting pattern be stored in the SF conversion table, the lighting pattern indicating lighting in at least one subfield selected from among the subfields, with respect to all luminances above a predetermined threshold.

This allows even a high-definition panel susceptible to the horizontal crosstalk to have the increased number of representable gradation levels while reducing occurrences of the horizontal crosstalk. Accordingly, in particular, a luminance discrepancy and a chromaticity discrepancy at a middle gradation level in a high-definition panel can be reduced effectively.

Furthermore, it is preferable that the image display unit include: a front substrate having a display electrode including a scanning electrode and a sustain electrode; and a rear substrate having a data electrode and facing the front substrate so that the data electrode intersects with the display electrode, discharge cells are formed between the front substrate and the rear substrate which face each other, in the subfield driving method, 1 TV field is composed of the subfields each having: a reset period in which a reset discharge is produced in at least one of the discharge cells; a write period in which an addressing discharge is produced in a discharge cell to be lighted among the discharge cells; and a sustain period in which a sustaining discharge is produced in the discharge cell in which the addressing discharge has been produced, at least one of the subfields have an all-cell reset discharge period in which all of the discharge cells produce reset discharges, and in the SF conversion table, the lighting pattern be stored which indicates lighting in a subfield which is included in the subfields and has the all-cell reset discharge period, with respect to all luminances above a predetermined threshold.

This allows for a control on which subfield requires lighting, according to a reset discharge method employed in the PDP and therefore makes it possible to reduce a luminance discrepancy and a chromaticity discrepancy more effectively.

Furthermore, it is preferable that the image display apparatus further include: an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color; a chromaticity correction table storage unit configured to store a chromaticity correction table in which chromaticity correction data for correcting the color signal of at least one of the blue and red colors is stored in association with the luminance indicated by the input color signal of the corresponding color; a light-emission characteristics correction unit configured to (i) obtain the light-emission luminance characteristics correction data associated with the luminance indicated by the input color signal of each of the colors, with reference to the LUT for each of the colors, and (ii) correct the input color signal of each of the colors using the obtained light-emission luminance characteristics correction data; a chromaticity correction data obtainment unit configured to obtain chromaticity correction data associated with the input color signal of at least one of the blue and red colors, with reference to the chromaticity correction table stored in the chromaticity correction table storage unit; and a chromaticity correction unit configured to correct, using the chromaticity correction data obtained by the chromaticity correction data obtainment unit, the color signal of a color associated with the chromaticity correction data among the color signals of the respective colors corrected by the light-emission characteristics correction unit, wherein the SF conversion unit is configured to obtain the lighting pattern associated with a luminance of the color signal corrected by the chromaticity correction unit.

This allows the color signal to be corrected based on the chromaticity discrepancy generated in the case of displaying white which is represented with a color mixture of red, green, and blue, with the result that it is possible to reduce the chromaticity discrepancy generated in the case where white is displayed using the subfield driving method. Moreover, a chromaticity discrepancy can be reduced by correcting part of the color signals corrected using the LUT for the corresponding color stored in advance, with the result that changes in the LUT can be minimized and a luminance discrepancy can also be reduced.

Furthermore, it is preferable that the image display apparatus further include: a chromaticity correction data calculation unit configured to, when a pixel color specified by the input color signals of the respective colors is white, (i) calculate chromaticity correction data of at least one of the blue and red colors based on a difference between a display chromaticity and a target chromaticity, the display chromaticity being a pixel chromaticity represented on the image display unit according to the color signals obtained by correcting the input color signals of the respective colors with reference to the LUT for each of the colors, and the target chromaticity being a pixel chromaticity specified by the input color signals of the respective colors, and (ii) store the calculated chromaticity correction data into the chromaticity correction table.

This allows the chromaticity correction data to be calculated based on the difference between the display chromaticity and the target chromaticity and therefore makes it possible to correct a chromaticity discrepancy with a higher degree of accuracy.

Furthermore, it is preferable that the chromaticity correction data calculation unit be configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number), the chromaticity correction data obtainment unit be configured to obtain the chromaticity correction data associated with the luminance indicated by the blue input color signal, with reference to the chromaticity correction table, and the chromaticity correction unit be configured to correct the blue color signal corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the blue color signal is corrected to correct a chromaticity discrepancy, it is possible to effectively reduce the chromaticity discrepancy in white having a color temperature less than 9,000K, for example.

Furthermore, it is preferable that the chromaticity correction data calculation unit be configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number), the chromaticity correction data obtainment unit be configured to obtain the chromaticity correction data associated with the luminance indicated by the red input color signal, with reference to the chromaticity correction table, and the chromaticity correction unit be configured to correct the red color signal corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the red color signal is corrected to correct a chromaticity discrepancy, it is possible to effectively reduce the chromaticity discrepancy in white having a color temperature of 9,000K or more, for example.

Furthermore, it is preferable that the chromaticity correction data calculation unit be configured to (i) decompose a vector into vectors in directions of two line segments, the vector being obtained by multiplying a chromaticity reduction vector heading for xy coordinates of the target chromaticity from xy coordinates of the measured display chromaticity by a luminance level of white indicated by the target chromaticity and by a predetermined coefficient α (where α is a positive real number), and the two line segments being a line segment linking the xy coordinates of the target chromaticity and xy coordinates indicating the chromaticity of blue and a line segment linking the xy coordinates of the target chromaticity and xy coordinates indicating the chromaticity of red, and (ii) calculate magnitudes of the vectors resulting from the vector decomposition, as the chromaticity correction data of the blue and red colors, the chromaticity correction data obtainment unit be configured to obtain the chromaticity correction data associated with the luminance indicated by the input color signals of the blue and red colors, with reference to the chromaticity correction table, and the chromaticity correction unit be configured to correct the input signals of the blue and red colors corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the red and blue color signals are corrected to correct a chromaticity discrepancy, it is possible to reduce the chromaticity discrepancy with a higher degree of accuracy.

Furthermore, it is preferable that the predetermined coefficient α be a predetermined value of 100 or less.

This allows the chromaticity correction data to be calculated using the coefficient α having an appropriate value and therefore makes it possible to reduce a chromaticity discrepancy with a high degree of accuracy.

Furthermore, it is preferable that the chromaticity correction unit be configured to correct the color signal when luminance levels indicated by the input color signals of the respective colors are substantially same.

This allows an effective reduction of the chromaticity discrepancy when a color mixture of red, green, and blue is displayed. This means that a luminance discrepancy can be reduced without execution of the processing for reducing a chromaticity discrepancy when an image is displayed with red, green, and blue colors not mixed or when the chromaticity discrepancy due to horizontal crosstalk does not likely to occur. In other words, it is possible to prevent a chromaticity discrepancy from occurring when white is displayed and to prevent a luminance discrepancy from occurring when a single color of red, green, or blue is displayed.

Furthermore, it is preferable that the chromaticity correction unit be configured to correct the color signal using a value obtained by multiplying the chromaticity correction data by a predetermined coefficient β (where β is a real number from 0 to 1 inclusive) which gradually increases as time passes from when the luminance levels indicated by the input color signals of the respective colors become substantially same.

This allows mitigation of a drastic luminance or chromaticity change which occurs upon switching between correcting and not correcting the chromaticity discrepancy.

Furthermore, the color signal correction apparatus according to an aspect of the present invention is a color signal correction apparatus that corrects color signals of red, green, and blue colors, which are provided to an image display unit that displays an image by causing pixels to produce luminescence using a subfield driving method, the pixels each including luminescent materials of red, green, and blue colors, the color signal correction apparatus including: an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color; a chromaticity correction table storage unit configured to store a chromaticity correction table for storing chromaticity correction data for correcting the color signal of at least one of the blue and red colors, in association with a luminance indicated by the input color signal of the corresponding color; a chromaticity correction data calculation unit configured to, when a pixel color specified by the input color signals of red, green, and blue colors is white, (i) calculate chromaticity correction data of at least one of the blue and red colors based on a difference between a display chromaticity and a target chromaticity, the display chromaticity being a pixel chromaticity represented on the image display unit according to the color signals obtained by correcting the input color signals of the respective colors with reference to the LUT for each of the colors, and the target chromaticity being a pixel chromaticity specified by the input color signals of the respective colors, and (ii) store the calculated chromaticity correction data into the chromaticity correction table; a light-emission characteristics correction unit configured to (i) obtain the light-emission luminance characteristics correction data associated with the luminance indicated by the input color signal of each of the red, green, and blue colors, with reference to the LUT for each of the colors, and (ii) correct the input color signal of each of the colors using the obtained light-emission luminance characteristics correction data; a chromaticity correction data obtainment unit configured to obtain chromaticity correction data associated with the input color signal of at least one of the blue and red colors, with reference to the chromaticity correction table stored in the chromaticity correction table storage unit; and a chromaticity correction unit configured to correct, using the chromaticity correction data obtained by the chromaticity correction data obtainment unit, the color signal of a color associated with the chromaticity correction data among the color signals of the respective colors corrected by the light-emission characteristics correction unit.

This allows the color signal to be corrected based on the chromaticity discrepancy generated in the case of displaying white which is represented with a color mixture of red, green, and blue, with the result that it is possible to reduce the chromaticity discrepancy generated in the case where white is displayed using the subfield driving method. Moreover, a chromaticity discrepancy can be reduced by correcting part of the color signals corrected using the LUT for the corresponding color stored in advance, with the result that changes in the LUT can be minimized and the luminance discrepancy can also be reduced.

Furthermore, the chromaticity correction data can be calculated based on the difference between the display chromaticity and the target chromaticity, which makes it possible to correct a chromaticity discrepancy with a higher degree of accuracy.

Furthermore, it is preferable that the chromaticity correction data calculation unit be configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number), the chromaticity correction data obtainment unit be configured to obtain the chromaticity correction data associated with the luminance indicated by the blue input color signal, with reference to the chromaticity correction table, and the chromaticity correction unit be configured to correct the blue color signal corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the blue color signal is corrected to correct a chromaticity discrepancy, it is possible to effectively reduce the chromaticity discrepancy in white having a color temperature less than 9,000K, for example.

Furthermore, it is preferable that the chromaticity correction data calculation unit be configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number), the chromaticity correction data obtainment unit be configured to obtain the chromaticity correction data associated with the luminance indicated by the red input color signal, with reference to the chromaticity correction table, and the chromaticity correction unit be configured to correct the red color signal corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the red color signal is corrected to correct a chromaticity discrepancy, it is possible to effectively reduce the chromaticity discrepancy in white having a color temperature of 9,000K or more, for example.

Furthermore, it is preferable that the chromaticity correction data calculation unit be configured to (i) decompose a vector into vectors in directions of two line segments, the vector being obtained by multiplying a chromaticity reduction vector heading for xy coordinates of the target chromaticity from xy coordinates of the measured display chromaticity by a luminance level of white indicated by the target chromaticity and by a predetermined coefficient α (where α is a positive real number), and the two line segments being a line segment linking the xy coordinates of the target chromaticity and xy coordinates indicating the chromaticity of blue and a line segment linking the xy coordinates of the target chromaticity and xy coordinates indicating the chromaticity of red, and (ii) calculate magnitudes of the vectors resulting from the vector decomposition, as the chromaticity correction data of the blue and red colors, the chromaticity correction data obtainment unit be configured to obtain the chromaticity correction data associated with the luminance indicated by the input color signals of the blue and red colors, with reference to the chromaticity correction table, and the chromaticity correction unit be configured to correct the input signals of the blue and red colors corrected by the light-emission characteristics correction unit, using the chromaticity correction data obtained by the chromaticity correction data obtainment unit.

With this, the chromaticity correction data associated with the luminance can be easily calculated from the chromaticity discrepancy generated when the image is actually displayed on the image display unit. In other words, this eliminates the need for caution to avoid major adjustment of the chromaticity in a region where the luminance indicated by the input color signal is low. In addition, because the red and blue color signals are corrected to correct a chromaticity discrepancy, it is possible to reduce the chromaticity discrepancy with a higher degree of accuracy.

Furthermore, it is preferable that the chromaticity correction unit be configured to correct the color signal when luminance levels indicated by the input color signals of the respective colors are substantially same.

This allows an effective reduction of the chromaticity discrepancy when an image is displayed with a color mixture of red, green, and blue. This means that a luminance discrepancy can be reduced without execution of the processing for reducing a chromaticity discrepancy when an image is displayed with red, green, and blue colors not mixed or when the chromaticity discrepancy due to horizontal crosstalk does not likely to occur. In other words, it is possible to prevent a chromaticity discrepancy from occurring when white is displayed and to prevent a luminance discrepancy from occurring when an image is displayed with a single color of red, green, or blue.

Furthermore, it is preferable that the chromaticity correction unit be configured to correct the color signal using a value obtained by multiplying the chromaticity correction data by a predetermined coefficient β (where β is a real number from 0 to 1 inclusive) which gradually increases as time passes from when the luminance levels indicated by the input color signals of the respective colors become substantially same.

This allows mitigation of a drastic luminance or chromaticity change which occurs upon switching between correcting and not correcting the chromaticity discrepancy.

Furthermore, the color signal correction method according to an aspect of the present invention is a color signal correction method for use in a color signal correction apparatus that corrects color signals of red, green, and blue colors, which are provided to an image display unit that displays an image by causing pixels to produce luminescence using a subfield driving method, the pixels each including luminescent materials of red, green, and blue colors, the color signal correction apparatus including: an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color; and a chromaticity correction table storage unit configured to store a chromaticity correction table for storing chromaticity correction data for correcting the color signal of at least one of the blue and red colors, in association with a luminance indicated by the input color signal of the corresponding color, the color signal correcting method including: calculating, when a pixel color specified by the input color signals of red, green, and blue colors is white, chromaticity correction data of at least one of the blue and red colors based on a difference between a display chromaticity and a target chromaticity, the display chromaticity being a pixel chromaticity represented on the image display unit according to the color signals obtained by correcting the input color signals of the respective colors with reference to the LUT for each of the colors, and the target chromaticity being a pixel chromaticity specified by the input color signals of the respective colors, and then storing the calculated chromaticity correction data into the chromaticity correction table; correcting light-emission characteristics by obtaining the light-emission luminance characteristics correction data associated with the luminance indicated by the input color signal of each of the red, green, and blue colors, with reference to the LUT for each of the colors, and then correcting the input color signal of each of the colors using the obtained light-emission luminance characteristics correction data; obtaining chromaticity correction data associated with the input color signal of at least one of the blue and red colors, with reference to the chromaticity correction table stored in the chromaticity correction table storage unit; and correcting, using the chromaticity correction data obtained in the obtaining, the color signal of a color corresponding to the chromaticity correction data among the color signals of the respective colors corrected in the correcting of light-emission characteristics.

This allows to provide the same effects as those given by the above color signal correction apparatus.

### Advantageous Effects of Invention

With the present invention, it is possible to provide an image display apparatus and a color signal correction apparatus which enable a significant reduction of at least one of a luminance discrepancy and a chromaticity discrepancy while reducing effects of horizontal crosstalk when displaying an image using the subfield driving method.

### BRIEF DESCRIPTION OF DRAWINGS

[FIG. 1]

FIG. 1 is a sectional perspective view showing a schematic structure of PDP as an example of an image display apparatus according to one embedment of the present invention which displays images using a color signal correction method according to one embodiment of the present invention and using a color signal correction apparatus according to one embodiment of the present invention by which the color signal correction method is implemented.

[FIG. 2]

FIG. 2 is a block diagram showing a functional structure of a color signal correction apparatus in the first embodiment of the present invention.

[FIG. 3]

FIG. 3 shows one example of a color correction table in the first embodiment of the present invention.

[FIG. 4A]

FIG. 4A is a block diagram showing a functional structure required to execute a process of the first step among functional structures of the color signal correction apparatus in the first embodiment of the present invention.

[FIG. 4B]

FIG. 4B is a block diagram showing a functional structure required to execute a process of the second step among the functional structures of the color signal correction apparatus in the first embodiment of the present invention.

[FIG. 5A]

FIG. 5A is a flowchart showing a process flow of the first step in the first embodiment of the present invention.

[FIG. 5B]

FIG. 5B is a flowchart showing a process flow of the second step in the first embodiment of the present invention.

[FIG. 6]

FIG. 6 shows a color signal correction result from a chromaticity correction apparatus in the first embodiment of the present invention.

[FIG. 7]

FIG. 7 is a block diagram showing a functional structure of a color signal correction apparatus in the second embodiment of the present invention.

[FIG. 8]

FIG. 8 is a chart for explaining a correction process executed by a color signal correction apparatus in the third embodiment of the present invention.

[FIG. 9]

FIG. 9 is a block diagram showing a functional structure of a color signal correction apparatus in the third embodiment of the present invention.

[FIG. 10]

FIG. 10 is a block diagram showing a functional structure of a color signal correction apparatus in the fourth embodiment of the present invention.

[FIG. 11]

FIG. 11 shows a functional structure of an image display apparatus in the fifth embodiment of the present invention.

[FIG. 12A]

FIG. 12A shows one example of a GSF conversion table in the fifth embodiment of the present invention.

[FIG. 12B]

FIG. 12B shows one example of an RSF conversion table and a BSF conversion table in the fifth embodiment of the present invention.

[FIG. 13]

FIG. 13 is a chart for explaining occurrence of horizontal crosstalk caused by an all-cell reset.

[FIG. 14]

FIG. 14 shows a functional structure of an image display apparatus in the sixth embodiment of the present invention.

[FIG. 15A]

FIG. 15A shows one example of a GSF conversion table in the sixth embodiment of the present invention.

[FIG. 15B]

FIG. 15B shows one example of an RSF conversion table and a BSF conversion table in the sixth embodiment of the present invention.

[FIG. 16A]

FIG. 16A is a chart for explaining a GSF conversion table in the sixth embodiment of the present invention.

[FIG. 16B]

FIG. 16B is a chart for explaining the RSF conversion table and the BSF conversion table in the sixth embodiment of the present invention.

[FIG. 17]

FIG. 17 is a block diagram showing a functional structure of an image display apparatus in a variation of the present invention.

[FIG. 18]

FIG. 18 is a chart for explaining a SF structure.

[FIG. 19]

FIG. 19 shows one example of a conventional SF conversion table.

[FIG. 20]

FIG. 20 is a chart for explaining a SF conversion table which is used to avoid the problems brought on by horizontal crosstalk.

[FIG. 21]

FIG. 21 shows the principle of horizontal crosstalk.

[FIG. 22]

FIG. 22 shows an occurrence pattern of horizontal crosstalk.

[FIG. 23]

FIG. 23 shows one example of the SF conversion table which is used to avoid the problems brought on by horizontal crosstalk.

[FIG. 24]

FIG. 24 shows a luminance discrepancy of each color and a chromaticity discrepancy of white at a color temperature of 9,000K in a conventional example.

[FIG. 25]

FIG. 25 shows a luminance discrepancy of each color and a chromaticity discrepancy of white at a color temperature of 5,600K in a conventional example.

### DESCRIPTION OF EMBODIMENTS

The following will describe a color signal correction apparatus, a color signal correction method, and an image display apparatus according to an embodiment of the present invention with reference to the drawings. It is to be noted that the present invention is not limited to the following embodiments.

### First Embodiment

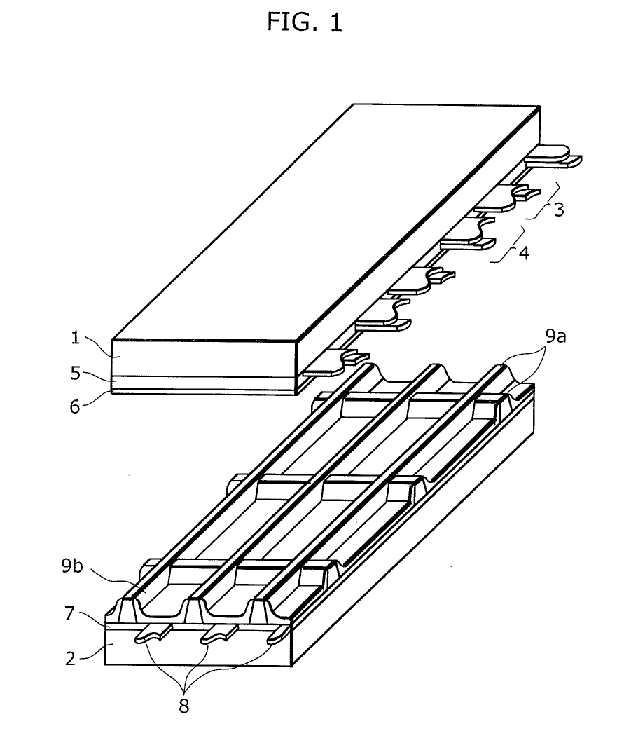

FIG. 1 is a sectional perspective view showing a schematic structure of PDP as an example of an image display apparatus according to one embedment of the present invention which displays images using a color signal correction method according to one embodiment of the present invention and using a color signal correction apparatus according to one embodiment of the present invention by which the color signal correction method is implemented.

As shown in FIG. 1, the PDP includes a front substrate 1 and a rear substrate 2 which face each other so that a discharge space is formed therebetween. On the front substrate 1, scanning electrodes 3 and sustain electrodes 4 are formed in parallel in pair. A dielectric layer 5 is formed so as to cover the scanning electors 3 and the sustain electrodes 4, and on the dielectric layer 5, a protective layer 6 is formed.

On the rear substrate 2, data electrodes 8 covered with an insulator layer 7 are provided, and on the insulator layer 7, barrier walls 9a are provided in grid form. On a surface of the insulator layer 7 and on side surfaces of the barrier walls 9a, a phosphor layer 9b is provided. The front substrate 1 and the rear substrate 2 are arranged oppositely from each other so that the scanning electrodes 3 and the sustain electrodes 4 intersect with the data electrodes 8, and the discharge space formed therebetween encloses, as discharge gas, mixed gas containing neon and xenon. A structure of the panel is not limited to the above-described one and may be provided with barrier walls arranged in stripe form, for example.

Next, the following will describe the color signal correction apparatus and the color signal correction method according to the one embodiment of the present invention, for driving the above PDP that is the image display apparatus according to the one embodiment of the present invention.

(Color Signal Correction Apparatus)

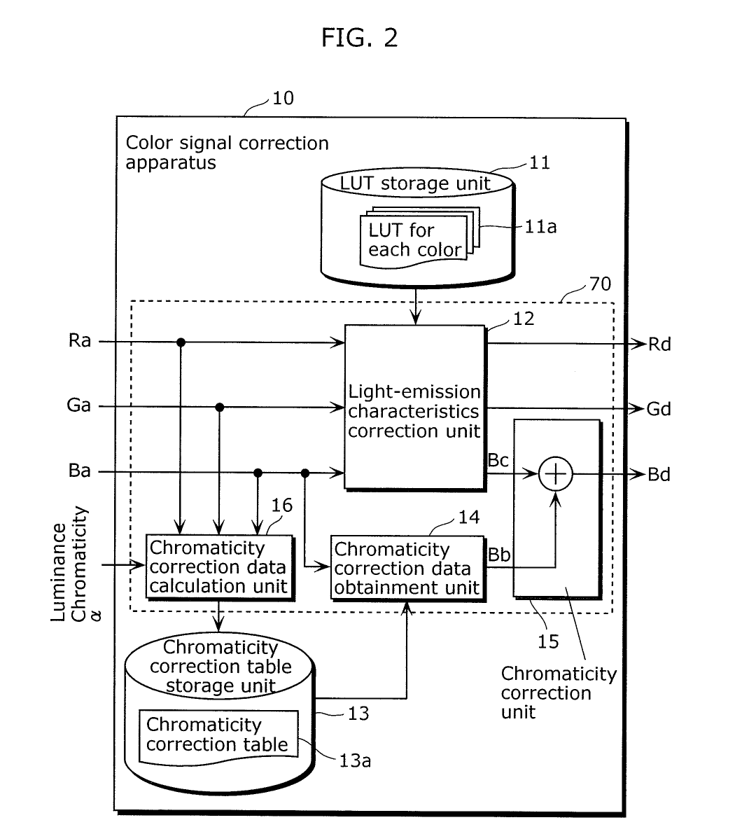

FIG. 2 is a block diagram showing a functional structure of the color signal correction apparatus in the first embodiment of the present invention.

A color signal correction apparatus 10 is an apparatus which performs a correction process on color signals of multiple colors (Ra, Ga, and Ba) from corresponding multiple luminescent materials which emit light of respective colors such that light-emission luminance characteristics of the luminescent materials of respective colors are corrected. In short, the color signal correction apparatus 10 corrects the red, green, and blue color signals which are to be outputted to an image display unit. It is to be noted that the image display unit displays an image by causing the luminescent materials to produce luminescence, using a subfield driving method in which a color at a middle gradation level is displayed by repeatedly lighting on and off the red, green, and blue colors. The color signal correction apparatus 10 includes an LUT storage unit 11, a light-emission characteristics correction unit 12, a chromaticity correction table storage unit 13, a chromaticity correction data obtainment unit 14, a chromaticity correction unit 15, and a chromaticity correction data calculation unit 16.

(LUT Storage Unit 11)

In the LUT storage unit 11, stored is LUT 11a for each of red, green, and blue colors, in which light-emission luminance characteristics correction data for correcting the light-emission luminance characteristics of the luminescent material of each color is associated with a luminance indicated by an input color signal of each color.

(Light-Emission Characteristics Correction Unit 12)

The light-emission characteristics correction unit 12 obtains the light-emission luminance characteristics correction data associated with the luminance indicated by the input color signal of each color, with reference to the LUT 11a for each color, in order to correct light-emission characteristics such as luminance saturation of the luminescent material. The light-emission characteristics correction unit 12 then corrects the input color signal of each color using the obtained light-emission luminance characteristics correction data. In other words, the light-emission characteristics correction unit 12 is a processing unit which changes a luminance level (Rd, Gd, Bc) of an output color signal relative to the luminance level (Ra, Ga, Ba) of the input color signal of each of red, green, and blue colors, according to the light-emission luminance of each pixel included in the display unit, thereby making corrections so that a light-emission luminance of the image display unit forms a linear pattern relative to the luminance level of the input color signal. As the light-emission characteristics correction unit 12, a non-linear correction circuit is preferably used.

The light-emission characteristics correction unit 12 may include a reverse gamma processing or cut-off driving function. Alternatively, the light-emission characteristics correction unit 12 may correct color signals processed by a processing unit including a reverse gamma processing or cut-off driving function.

(Chromaticity Correction Table Storage Unit 13)

The chromaticity correction table storage unit 13 stores a chromaticity correction table 13a which holds chromaticity correction data (which may be hereinafter referred to as a chromaticity correction value) calculated by the chromaticity correction data calculation unit 16. In the chromaticity correction table 13a, the chromaticity correction value for correcting the blue color signal is stored in association with the luminance level (Ba) indicated by the input blue color signal.

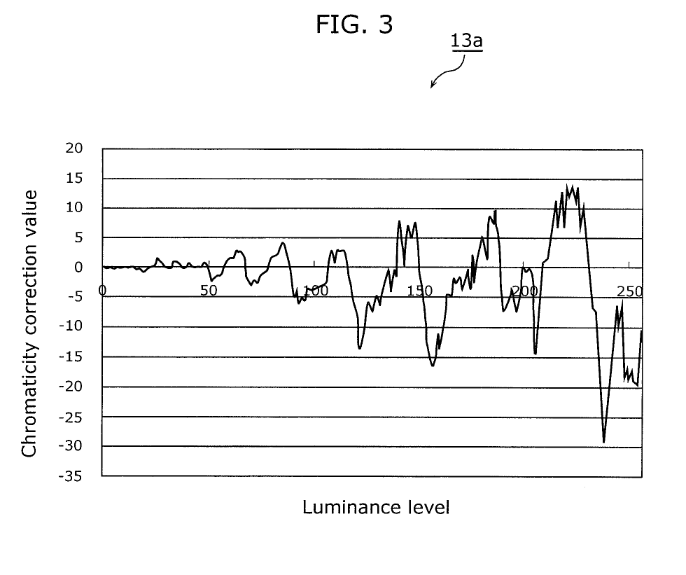

FIG. 3 shows one example of the chromaticity correction table. As shown in FIG. 3, the chromaticity correction table 13a holds a chromaticity correction value (Bb) which forms a non-linear pattern relative to the luminance level (Ba) of the input blue color signal.

(Chromaticity Correction Data Obtainment Unit 14)

The chromaticity correction data obtainment unit 14 obtains a chromaticity correction value which is associated with the luminance level (Ba) indicated by the input blue color signal, with reference to the chromaticity correction table 13a stored in the chromaticity correction table storage unit 13.

(Chromaticity Correction Unit 15)

The chromaticity correction unit 15 is a processing unit for mitigating a chromaticity change which occurs along with the change of the luminance level of the input white color signal. In other words, the chromaticity correction unit 15 corrects the blue color signal, among the color signals of the respective colors corrected by the light-emission characteristics correction unit 12, using the chromaticity correction data obtained by the chromaticity correction data obtainment unit 14. To be specific, the chromaticity correction unit 15 adds the chromaticity correction value (Bb) which is associated with the luminance level (Ba) of the input blue color signal and has been obtained by the chromaticity correction data obtainment unit 14, to the luminance level (Bc) corrected by the light-emission characteristics correction unit 12, thus correcting the luminance level (Bc) into a luminance level (Bd).

(Chromaticity Correction Data Calculation Unit 16)

The chromaticity correction data calculation unit 16 is a processing unit which calculates the chromaticity correction data to be stored in the chromaticity correction table, before the color signal is corrected by the chromaticity correction unit 15 or the like. To be specific, the chromaticity correction data calculation unit 16 calculates a chromaticity correction value by multiplying a “y” chromaticity discrepancy by a white luminance level which is converted into 0 to 255 levels and then multiplying the resultant value by a coefficient α. In other words, the chromaticity correction data calculation unit 16 multiplies a difference value between a y-coordinate of a target chromaticity and a y-coordinate of a measured display chromaticity by the white luminance level indicated by the target chromaticity. The chromaticity correction data calculation unit 16 then determines as the chromaticity correction value the value α times the value resulting from the above multiplication. In addition, the chromaticity correction data calculation unit 16 stores in the chromaticity correction table 13a the resultant chromaticity correction value in association with the luminance level indicated by the blue color signal.

The coefficient α is a positive real number. It is to be noted that the coefficient α is preferably a predetermined and fixed positive value of 100 or less. Furthermore, the reason why the chromaticity discrepancy is multiplied by the white luminance is that even for the same chromaticity discrepancy, the correction on B luminance should be made weaker for a lower luminance and stronger for a higher luminance.

In the case of white at a color temperature of 5,600K, the chromaticity discrepancy y and the chromaticity discrepancy x change in almost the same way, and the chromaticity correction data calculation unit 16 may thus calculate the chromaticity correction data for blue using the chromaticity discrepancy x.

Next, the operation of the color signal correction apparatus 10 configured as above will be described.

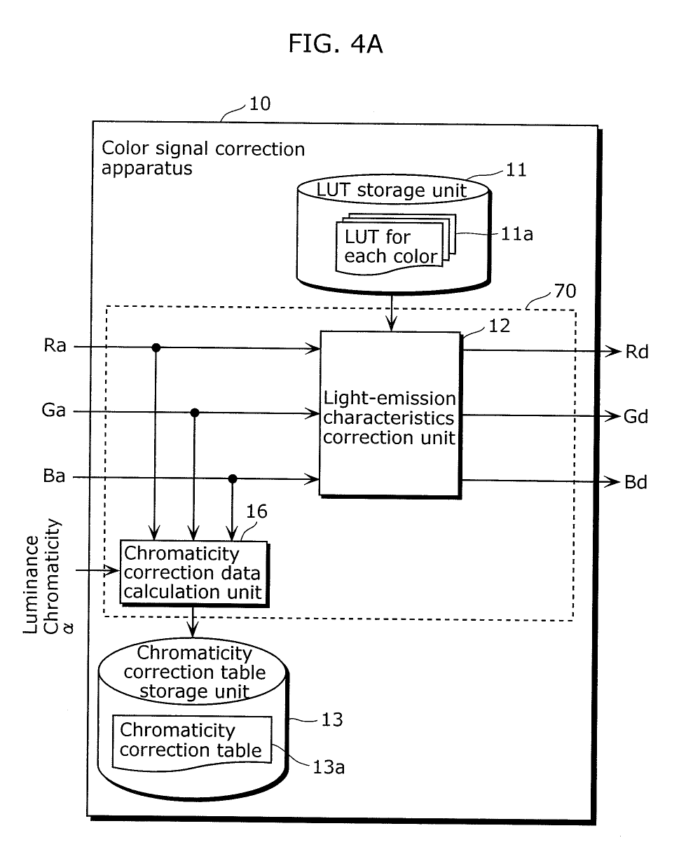

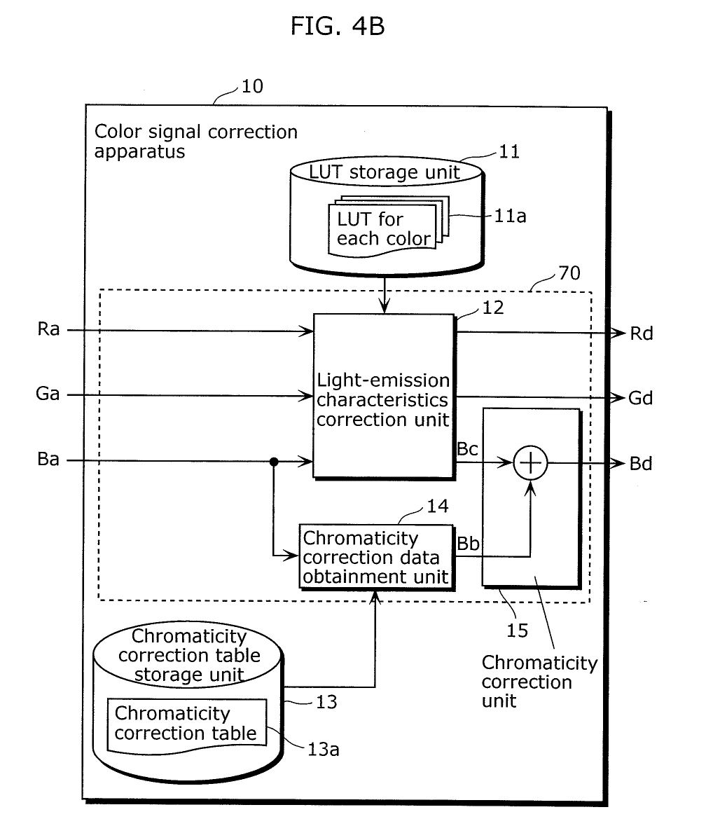

Of the color signal correction apparatus 10, different structures are used in the first step of creating the chromaticity correction table 13a and storing it in the chromaticity correction table storage unit 13 with use of the chromaticity correction data calculation unit 16 and in the second step of making the chromaticity corrections with reference to the chromaticity correction table 13a stored in the chromaticity correction table storage unit 13. To be specific, in the first step, the LUT storage unit 11, the light-emission characteristics correction unit 12, the chromaticity correction data calculation unit 16, and the chromaticity correction table storage unit 13 are used as shown in FIG. 4A. In the second step, the LUT storage unit 11, the light-emission characteristics correction unit 12, the chromaticity correction table storage unit 13, the chromaticity correction data obtainment unit 14, and the chromaticity correction unit 15 are used as shown in FIG. 4B.

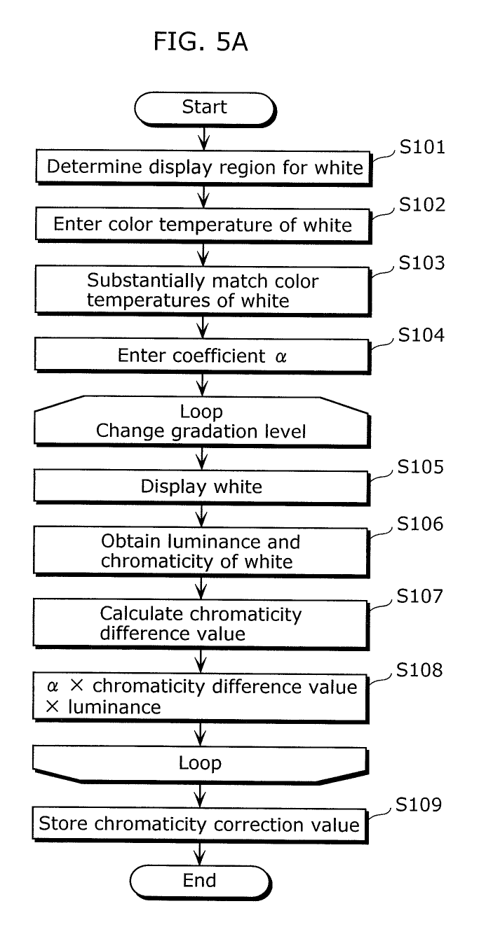

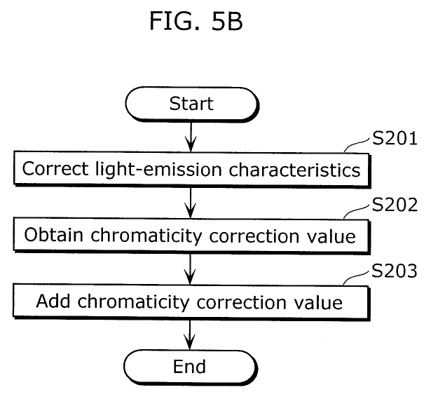

FIG. 5A is a flowchart showing a process flow of the first step in the first embodiment of the present invention. The process of the first step may also be executed by a user.

First of all, a window region (all or part of a screen included in the image display unit) for displaying white is determined (Step S101). For example, a rectangular region positioned at a center of the screen and occupying an area of 10% to 30% of the total area of the screen is determined as the window region for displaying white.

Next, a color temperature of white which is used to create the chromaticity correction data is determined and provided to the chromaticity correction data calculation unit 16 (Step S102). For example, a remote control or the like is used to enter the color temperature of white. The color temperature may also be determined according to a color temperature held in advance.

Next, a color temperature of white to be displayed in the window region is adjusted to substantially match with the input color temperature (Step S103). In the case where a new color temperature not held in advance is entered, a cut-off driving function for color signals is used to change a ratio of the RGB color signals so that the color temperature of white displayed substantially matches with the entered new color temperature. Instead, the LUT for each color in the light-emission characteristics correction unit may be changed to substantially match the color temperature of white with the entered color temperature.

Next, the coefficient α is determined and provided to the chromaticity correction data calculation unit 16 (Step S104). For example, an initial value (e.g., “40”) held in advance may be determined as the coefficient α.

Next, the image display apparatus repeats the following processing from Step S105 to Step S107 for all the gradation levels as it changes the gradation level. To be specific, the image display apparatus executes the processing as it gradually increments the gradation level from 0 to 255.

The image display apparatus including the image display unit displays in the determined window region an image of white at the color temperature which has bee adjusted to substantially match with the entered color temperature (Step S105). At this time, the image display apparatus displays the image according to the input color signal corrected by the light-emission characteristics correction unit 12.

The chromaticity correction data calculation unit 16 obtains as a display chromaticity the actually measured chromaticity of the image of white displayed in the window region. In addition, the chromaticity correction data calculation unit 16 obtains the actually measured luminance level of the image displayed in the window region (Step S106).

The chromaticity correction data calculation unit 16 then calculates for each gradation level a difference value between a y-coordinate value of the obtained display chromaticity and a y-coordinate value of a chromaticity (target chromaticity) which is based on the color temperature determined in Step S102 (Step S107). In addition, the chromaticity correction data calculation unit 16 determines a chromaticity correction value by multiplying for each gradation level the resultant difference value, the obtained luminance level, and the determined coefficient α (Step S108).

The chromaticity correction value thus determined is then stored in the chromaticity correction table 13a in association with the luminance level indicated by the input blue color signal which is specified using corresponding gradation level and color temperature (Step S109).

It is to be noted that although the chromaticity correction data calculation unit 16 determines one coefficient α regardless of the gradation level, the coefficient α may be determined for each of the gradation levels. In that case, the step S104 is included in the loop.

It may also be possible that the chromaticity correction data calculation unit 16 calculates a chromaticity correction value candidate for each of the coefficients α and stores it in a chromaticity correction table candidate. In this case, the chromaticity correction data calculation unit 16 selects, from among the chromaticity correction table candidates, a chromaticity correction table candidate with which the difference between the target chromaticity and the display chromaticity is smallest.

In Step S102, instead of the color temperature, the chromaticity of white (x-coordinate and y-coordinate) may be determined. In this case, in Step S103, the chromaticity of white to be displayed in the window region is adjusted to substantially match with the entered chromaticity. Furthermore, in Step S107, the chromaticity correction data calculation unit 16 calculates for each gradation level a difference value between the y-coordinate value of the obtained display chromaticity and the y-coordinate value of the chromaticity (target chromaticity) determined in Step S102. The above processing from Step S101 to Step S109 effects storage of the chromaticity correction value into the chromaticity correction table 13a.

FIG. 5B is a flowchart showing a process flow of the second step in the first embodiment of the present invention.

The light-emission characteristics correction unit 12 obtains the light-emission luminance characteristics correction data which is associated with the luminance indicated by the input color signal of each color, with reference to the LUT 11a for each color stored in the LUT storage unit 11. The light-emission characteristics correction unit 12 then corrects the input color signal of each color using the obtained light-emission luminance characteristics correction data (Step S201). To be specific, the light-emission characteristics correction unit 12 generates, as a corrected color signal, a light-emission characteristics correction value (e.g., “95”) which is associated with a luminance level (e.g., “100”) stored in the LUT for each color and indicated by an input color signal of each color.

The chromaticity correction data obtainment unit 14 then obtains a chromaticity correction value which is associated with the input blue color signal, with reference to the chromaticity correction table 13a stored in the chromaticity correction table storage unit 13 (Step S202). For example, the chromaticity correction data obtainment unit 14 obtains a chromaticity correction value “−5” associated with a luminance level “100” of the input color signal, with reference to the chromaticity correction table 13a shown in FIG. 3.

Lastly, the chromaticity correction unit 15 corrects the blue color signal corrected by the light-emission characteristics correction unit 12, using the chromaticity correction data obtained by the chromaticity correction data obtainment unit 14 (Step S203). To be specific, the chromaticity correction unit 15 adds the chromaticity correction value “−5” to the luminance level “95” of the corrected color signal, for example.

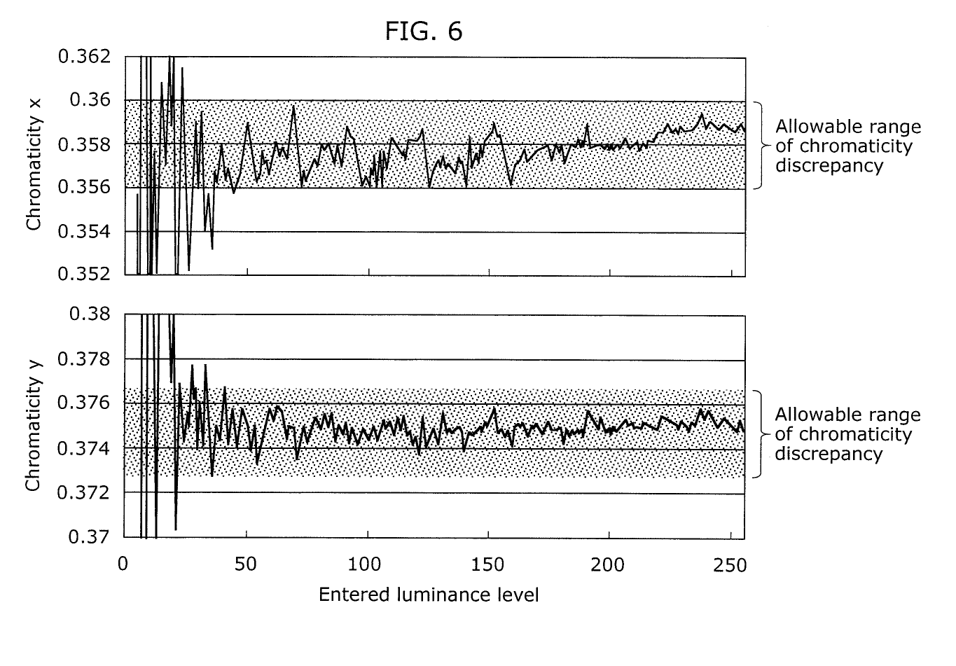

The color signal correction apparatus 10 as above was placed in an image display apparatus including a PDP (image display unit), and displaying an image thereon in practice allows reduction in chromaticity change as shown in FIG. 6, in the gradation characteristics of white, which had been a problem. In this case, the coefficient α was 40. The image display apparatus was able to display a favorable image, even of a nature scene. When the coefficient α is a positive real number below 100, relatively favorable effects are obtained. Particularly, when the coefficient α was 40, a good experimental result was obtained.

As above, the color signal correction apparatus 10 in the present embodiment is capable of correcting the color signal based on the chromaticity discrepancy generated in the case of displaying white which is represented with a color mixture of red, green, and blue, and is therefore capable of reducing the chromaticity discrepancy generated in the case where white is displayed using the subfield driving method. Moreover, the color signal correction apparatus 10 is capable of reducing the chromaticity discrepancy by correcting part of the color signals corrected using the LUT for the corresponding color stored in advance and is thus capable of minimizing changes in the LUT and also reducing the luminance discrepancy.

Furthermore, the color signal correction apparatus 10 is capable of easily calculating the chromaticity correction data associated with to the luminance, based on the difference between the display chromaticity and the target chromaticity. That is, the color signal correction apparatus 10 uses the calculated chromaticity correction data to enable correction on the input color signal having a low luminance without large changes in chromaticity and luminance. In addition, the color signal correction apparatus 10 corrects the blue color signal in order to correct the chromaticity discrepancy, and is thus capable of effectively reducing the chromaticity discrepancy in white having a color temperature less than 9,000K, for example.

If the color temperature is higher than 9,000K, it is preferable that the chromaticity correction unit 15 correct a red color signal. This is because blue has a large impact when the color temperature of white is lower than 9,000K, while red has a large impact when the color temperature of white is higher than 9,000K. To correct the red color signal, the color signal correction apparatus 10 makes the above-described corrections with the blue color signal replaced by red color signal.

Although the color signal correction apparatus 10 includes the chromaticity correction data calculation unit 16 in the present embodiment, the color signal correction apparatus 10 does not necessarily need to include the chromaticity correction data calculation unit 16. In that case, the color signal correction apparatus 10 stores the color signal correction data calculated in advance by a computer or the like, into the chromaticity correction table storage unit 13, for example.

Furthermore, although the chromaticity correction table 13a is stored in the chromaticity correction table storage unit 13 in the present embodiment, the chromaticity correction data stored in the chromaticity correction table 13a may be reflected in the LUT for blue. In this case, the color signal correction apparatus 10 does not require the chromaticity correction table storage unit 13, the chromaticity correction data obtainment unit 14, and the chromaticity correction unit 15.

### Second Embodiment

Next, the second embodiment of the present invention will be described.

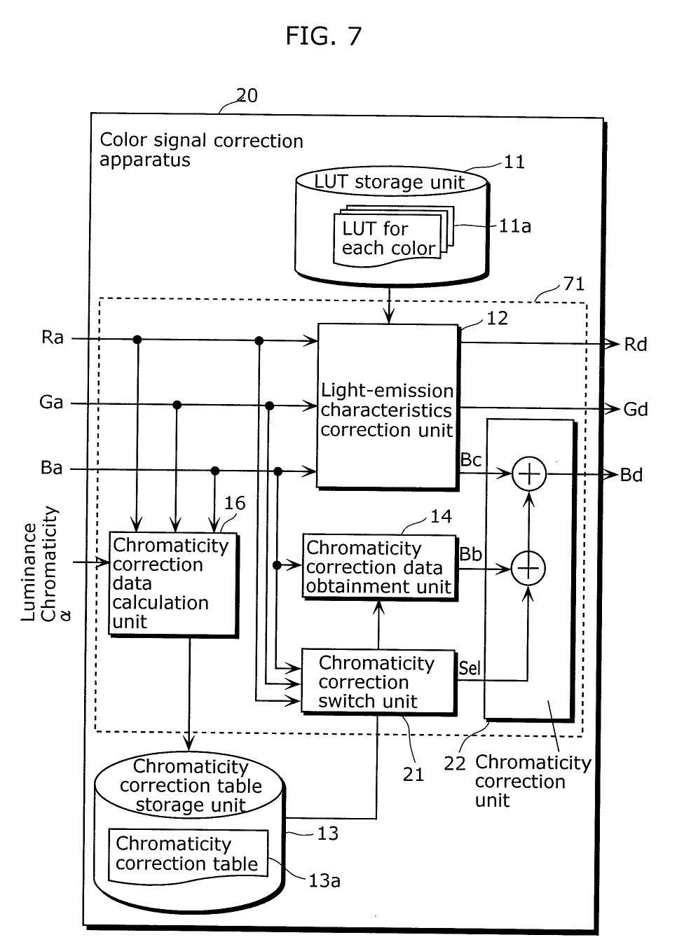

In the first embodiment, the color signal correction apparatus 10 uses the chromaticity correction data to correct the B color signal so as to mitigate changes in the chromaticity of white. However, if the colors of pixels specified by the input color signals of respective colors are a single color of B, the correction using the chromaticity correction data causes a luminance discrepancy of B. For this reason, in the second embodiment, a color signal correction apparatus 20 further includes a chromaticity correction switch unit 21 as shown in FIG. 7.

FIG. 7 is a block diagram showing a functional structure of the color signal correction apparatus in the second embodiment of the present invention. Elements common to FIG. 2 retain the same numerals in FIG. 7 so that explanation is omitted.

(Chromaticity Correction Switch Unit 21)

The chromaticity correction switch unit 21 switches between correcting and not correcting the color signal in a chromaticity correction unit 22, according to a balance of the luminance level among the input color signals of the respective colors of RGB. To be specific, when the luminance levels indicated by the input color signals of the respective colors of RGB are substantially the same, the chromaticity correction switch unit 21 provides a switch signal indicating e.g., “1” to the chromaticity correction unit 22. On the other hand, when the luminance levels indicated by the input color signals of the respective colors of RGB are not substantially the same, the chromaticity correction switch unit 21 provides a switch signal indicating e.g., “0” to the chromaticity correction unit 22. Here, substantially the same means not only the exactly the same but also close enough to regard as the same. Specifically, substantially the same means that each difference value between the luminance levels of the input color signals of the respective colors does not exceed a predetermined reference value.

### (Chromaticity Correction Unit 22)

The chromaticity correction unit 22 corrects the color signal when the luminance levels indicated by the input color signals of the respective colors are substantially the same. To be specific, the chromaticity correction unit 22 multiplies the chromaticity correction value Bb obtained by the chromaticity correction data obtainment unit 14, by a value Sel indicated by the switch signal provided by the chromaticity correction switch unit 21, for example. The chromaticity correction unit 22 then adds the value resulting from the multiplication, to the luminance level Bc of the blue color signal corrected by the light-emission characteristics correction unit 12.

As above, the color signal correction apparatus 20 in the present embodiment is capable of effectively reducing a chromaticity discrepancy only when a color mixture of red, green, and blue is displayed. This means that the color signal correction apparatus 20 is capable of reducing a luminance discrepancy, without executing the processing for reducing a chromaticity discrepancy when an image is displayed with red, green, and blue colors not mixed or when the chromaticity discrepancy due to horizontal crosstalk does not likely to occur. In other words, the color signal correction apparatus 20 is capable of preventing a chromaticity discrepancy from occurring when white is displayed and preventing a luminance discrepancy from occurring when a single color of red, green, or blue is displayed.

In the case where the colors of pixels specified by the input color signals of respective colors are close to white, repeated changes of the chromaticity correction unit 22 between correcting and not correcting the color signal (ON and OFF) may lead to such wide fluctuations in chromaticity of white as to cause a noticeable flicker. It is therefore preferable that the chromaticity correction unit 22 make gradual changes between correcting and not correcting the color signal. To be specific, the chromaticity correction unit 22 corrects the color signal preferably using a value obtained by multiplying the chromaticity correction data by a coefficient β (where β is a real number from 0 to 1 inclusive), which gradually increases up to the maximum value as time passes from when the luminance levels indicated by the input color signals of the respective colors become substantially the same.

When a single color B is displayed, the luminance discrepancy has little impact on image quality, and switching of the correction processing in the chromaticity correction unit 22 is therefore not indispensable.

Although not described, the operation of the color signal correction apparatus 20 in the present embodiment is divided into the first step and the second step as in the case of the operation of the color signal correction apparatus 10 in the first embodiment. Specifically, in the first step, the color signal correction apparatus 20 creates the chromaticity correction table 13a and stores it in the chromaticity correction table storage unit 13 with use of the LUT storage unit 11, the light-emission characteristics correction unit 12, the chromaticity correction data calculation unit 16, and the chromaticity correction table storage unit 13. In the second step, the color signal correction apparatus 20 makes the chromaticity corrections with reference to the chromaticity correction table 13a stored in the chromaticity correction table storage unit 13 with use of the LUT storage unit 11, the light-emission characteristics correction unit 12, the chromaticity correction table storage unit 13, the chromaticity correction data obtainment unit 14, the chromaticity correction switch unit 21, and the chromaticity correction unit 22.

### Third Embodiment

Next, the third embodiment of the present invention will be described.

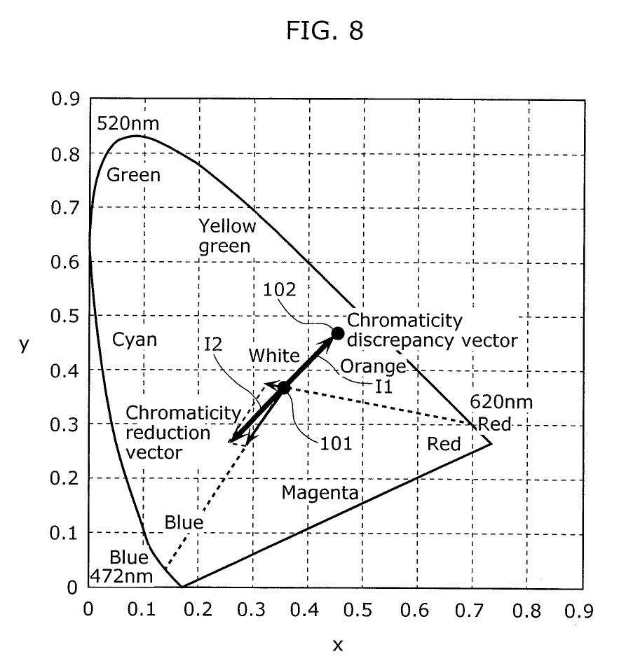

In the first embodiment, the color signal correction apparatus 10 reduces the chromaticity discrepancy by adjusting the luminance level of blue with use of a value of the chromaticity discrepancy y, when the color temperature is low. However, as shown in FIG. 8, a direction of the discrepancy between the target chromaticity and the display chromaticity is slightly different from a direction of a line connecting the target chromaticity and the chromaticity of blue, which means that the color signal correction apparatus 10 in the first embodiment, which adjusts only the luminance level of blue, is not capable of completely reducing the chromaticity discrepancy. In the present embodiment, therefore, a color signal correction apparatus 30 corrects the luminance levels of both blue and red based on the difference between the target chromaticity and the measured display chromaticity, thus reducing the chromaticity discrepancy with a high degree of accuracy.

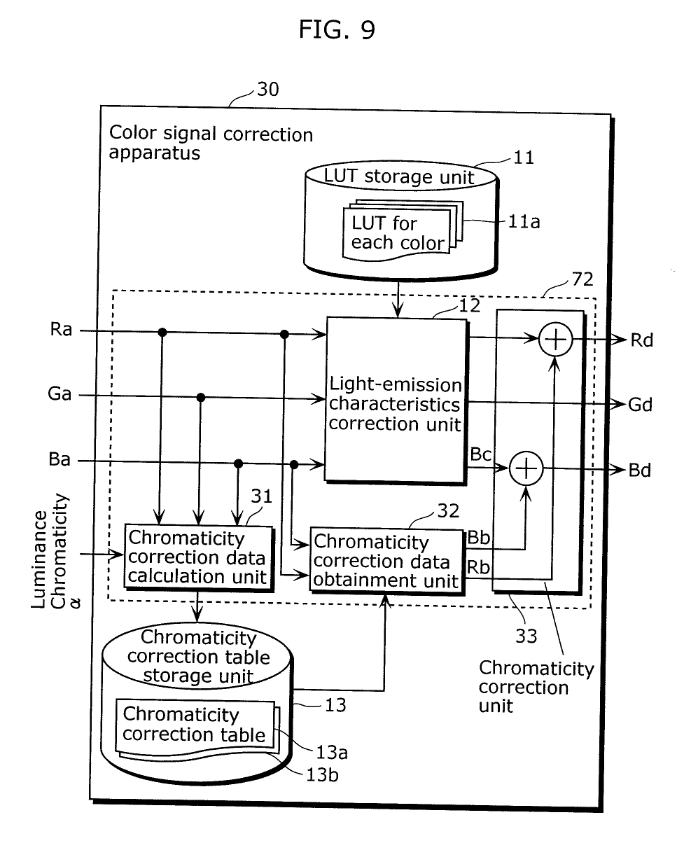

FIG. 9 is a block diagram showing a functional structure of the color signal correction apparatus in the third embodiment of the present invention. Elements common to FIG. 2 retain the same numerals in FIG. 9 so that explanation is omitted.

As shown in FIG. 8, a chromaticity discrepancy vector I1 is a vector heading for the xy coordinates of a display chromaticity 102 from the xy coordinates of a target chromaticity 101 when there is a chromaticity discrepancy in a direction from the target chromaticity 101 to the display chromaticity 102. In order to reduce the chromaticity discrepancy vector I1, the chromaticity correction data calculation unit 31 corrects the luminance indicated by the color signal according to a chromaticity reduction vector I2 (=−I1), which is opposite to the chromaticity discrepancy vector I1. This chromaticity reduction vector I2 coincides with the vector heading for the xy coordinates of the display chromaticity 102 from the xy coordinates of the target chromaticity 101.

(Chromaticity Correction Data Calculation Unit 31)

The chromaticity correction data calculation unit 31 performs vector decomposition so that the chromaticity reduction vector I2 is decomposed into vectors in a chromaticity direction from the target chromaticity toward R (e.g., 620 nm in wavelength) and in a chromaticity direction from the target chromaticity toward B (e.g., 472 nm in wavelength). A length of each of the vectors resulting from the vector decomposition is then multiplied by the luminance level of white indicated by the target chromaticity and the coefficient α, and the resultant value is stored as chromaticity correction data of R and B into the chromaticity correction table 13b or 13a. In the above, the vector decomposition and the multiplication may be performed in any order. That is, the chromaticity correction data calculation unit 31 may perform the vector decomposition after the multiplication.

To be specific, the chromaticity correction data calculation unit 31 may multiply the luminance level of white indicated by the target chromaticity and the coefficient α by the chromaticity reduction vector heading for the xy coordinates of the target chromaticity from the xy coordinates of the measured display chromaticity. The chromaticity correction data calculation unit 31 may then perform vector decomposition so that a vector resulting from the multiplication is decomposed into vectors in directions of two line segments which links the xy coordinates of the target chromaticity and an xy coordinates of chromaticity of blue and which links the xy coordinates of the target chromaticity and an xy coordinates of chromaticity of red. In addition, the chromaticity correction data calculation unit 31 may calculate a magnitude of each of the vectors resulting from the vector decomposition as the chromaticity correction data.

(Chromaticity Correction Data Obtainment Unit 32)

A chromaticity correction data obtainment unit 32 obtains chromaticity correction data of blue and red with reference to the chromaticity correction tables 13a and 13b in which the chromaticity correction data is stored by the chromaticity correction data calculation unit 31 as above.

(Chromaticity Correction Unit 33)

A chromaticity correction unit 33 corrects the blue and red color signals corrected by the light-emission characteristics correction unit 12, using the chromaticity correction data of blue and red obtained by the chromaticity correction data obtainment unit 32.

As above, the color signal correction apparatus 30 in the present embodiment is capable of calculating the chromaticity correction data of blue and red, using the chromaticity reduction vector heading for the xy coordinates of the target chromaticity from the xy coordinates of the display chromaticity. Using the chromaticity correction data of blue and red thus calculated, the color signal correction apparatus 30 corrects both of the input red and blue color signals, allowing for a reduction in chromaticity discrepancy with a higher degree of accuracy. Providing the image display apparatus including a PDP with the color signal correction apparatus 30 in the present embodiment will therefore allow the image display apparatus to further reduce the chromaticity discrepancy of white.

Although not described, the operation of the color signal correction apparatus 30 in the present embodiment is divided into the first step and the second step as in the case of the operation of the color signal correction apparatus 10 in the first embodiment. Specifically, in the first step, the color signal correction apparatus 30 creates the chromaticity correction tables 13a and 13b and stores them in the chromaticity correction table storage unit 13 with use of the LUT storage unit 11, the light-emission characteristics correction unit 12, the chromaticity correction data calculation unit 31, and the chromaticity correction table storage unit 13. In the second step, the color signal correction apparatus 30 makes the chromaticity corrections with reference to the chromaticity correction tables 13a and 13b stored in the chromaticity correction table storage unit 13 with use of the LUT storage unit 11, the light-emission characteristics correction unit 12, the chromaticity correction table storage unit 13, the chromaticity correction data obtainment unit 32, and the chromaticity correction unit 33.

### Fourth Embodiment

Next, the fourth embodiment of the present invention will be described.

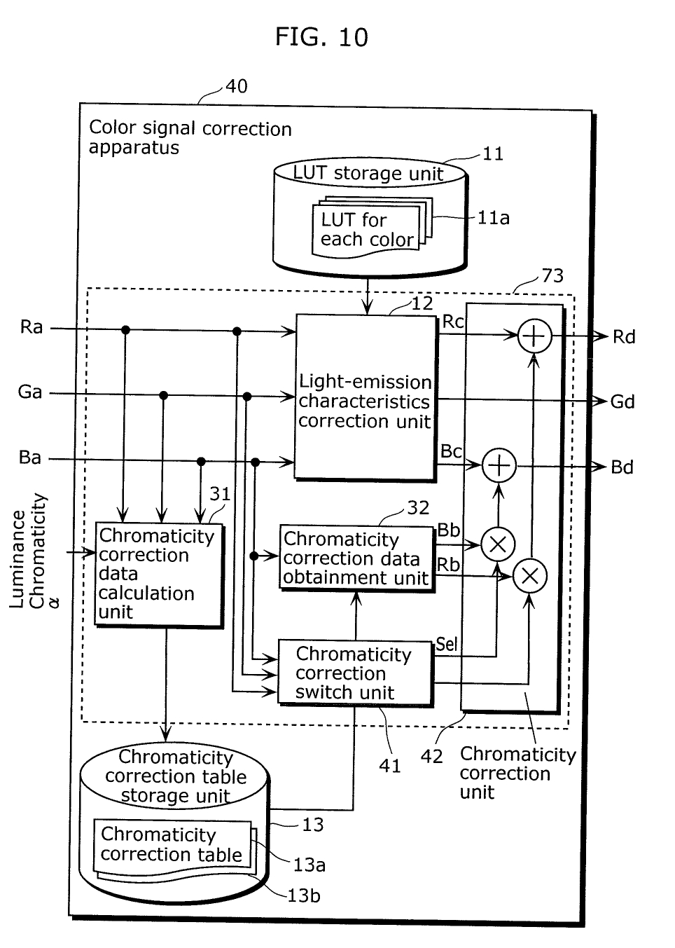

In the third embodiment, the color signal correction apparatus 30 uses the chromaticity correction data to correct the R and B color signals so as to mitigate changes in the chromaticity of white. However, when the colors of pixels specified by the input RGB color signals are a single color of R or B, the correction using the chromaticity correction data generates a luminance discrepancy of R or B. For this reason, in the fourth embodiment, a color signal correction apparatus 40 further includes a chromaticity correction switch unit 41 as shown in FIG. 10.

FIG. 10 is a block diagram showing a functional structure of the color signal correction apparatus in the fourth embodiment of the present invention. Elements common to FIG. 10 retain the same numerals in FIG. 10 so that explanation is omitted.

(Chromaticity Correction Switch Unit 41)

The chromaticity correction switch unit 41 switches between correcting and not correcting the color signal in a chromaticity correction unit 42, according to a balance of the luminance level among the input color signals of respective colors of RGB. To be specific, when the luminance levels indicated by the input color signals of the respective colors of RGB are substantially the same, the chromaticity correction switch unit 41 provides a switch signal indicating e.g., “1” to the chromaticity correction unit 42. On the other hand, when the luminance levels indicated by the input color signals of the respective colors of RGB are not substantially the same, the chromaticity correction switch unit 41 provides a switch signal indicating e.g., “0” to the chromaticity correction unit 42.

(Chromaticity Correction Unit 42)

The chromaticity correction unit 42 corrects the color signal when the luminance levels indicated by the input color signals of the respective colors are substantially the same. To be specific, the chromaticity correction unit 42 multiplies the chromaticity correction value Bb for blue obtained by the chromaticity correction data obtainment unit 14, by a value Sel indicated by the switch signal provided by the chromaticity correction switch unit 41, for example. The chromaticity correction unit 42 then adds the value resulting from the multiplication, to the luminance level Bc of the blue color signal corrected by the light-emission characteristics correction unit 12. Furthermore, the chromaticity correction unit 42 multiplies the chromaticity correction value Rb for red obtained by the chromaticity correction data obtainment unit 14, by a value Sel indicated by the switch signal provided by the chromaticity correction switch unit 41, for example. The chromaticity correction unit 42 then adds the value resulting from the multiplication, to the luminance level Rc of the red color signal corrected by the light-emission characteristics correction unit 12.

As above, the color signal correction apparatus 40 in the present embodiment is capable of effectively reducing the chromaticity discrepancy only when a color mixture of red, green, and blue is displayed. This means that the color signal correction apparatus 40 is capable of reducing a luminance discrepancy, without executing the processing for reducing a chromaticity discrepancy when an image is displayed with red, green, and blue colors not mixed or when the chromaticity discrepancy due to horizontal crosstalk does not likely to occur. In other words, the color signal correction apparatus 40 is capable of preventing a chromaticity discrepancy from being generated when white is displayed and preventing a luminance discrepancy from being generated when a single color of red, green, or blue is mixed.

In the case where the colors of pixels specified by the input color signals of respective colors are close to white, repeated changes of the chromaticity correction unit 42 between correcting and not correcting the color signal (ON and OFF) may lead to such wide fluctuations in chromaticity of white as to cause a noticeable flicker. It is therefore preferable that the chromaticity correction unit 42 make gradual changes between correcting and not correcting the color signal. To be specific, the chromaticity correction unit 42 corrects the color signal preferably using a value obtained by multiplying the chromaticity correction data by a coefficient β (β is a real number from 0 to 1 inclusive), which gradually increases as time passes from when the luminance levels indicated by the input color signals of the respective colors become substantially the same.

When a single color of red or blue is displayed, the luminance discrepancy has little impact on image quality, and switching of the correction processing in the chromaticity correction unit 42 is therefore not indispensable.

Although not described, the operation of the color signal correction apparatus 40 in the present embodiment is divided into the first step and the second step as in the case of the operation of the color signal correction apparatus 10 in the first embodiment. Specifically, in the first step, the color signal correction apparatus 40 creates the chromaticity correction tables 13a and 13b and stores them in the chromaticity correction table storage unit 13 with use of the LUT storage unit 11, the light-emission characteristics correction unit 12, the chromaticity correction data calculation unit 16, and the chromaticity correction table storage unit 13. In the second step, the color signal correction apparatus 40 makes the chromaticity corrections with reference to the chromaticity correction tables 13a and 13b stored in the chromaticity correction table storage unit 13 with use of the LUT storage unit 11, the light-emission characteristics correction unit 12, the chromaticity correction table storage unit 13, the chromaticity correction data obtainment unit 32, the chromaticity correction switch unit 41, and the chromaticity correction unit 42.

### Fifth Embodiment

Next, the fifth embodiment of the present invention will be described.

In the above first to fourth embodiments, the color signal correction apparatus reduces the chromaticity discrepancy by correcting the color signal with reference to the chromaticity correction table and the LUT for each color. The color signal correction apparatus in the above first to fourth embodiments is capable of representing a pure R, G, B, or W with a high degree of accuracy, but has a difficulty in accurate representation of other colors at a middle gradation level. In order to represent a color at a middle gradation level with a high degree of accuracy, it is necessary to radically reduce the luminance discrepancy which is generated when a mixture of the colors is displayed.

When a mixture of the colors is displayed, the luminance discrepancy is generated on a gradation level to which an error diffusion method or dithering is applied for complimenting the gradation level which is not covered by a subfield lighting pattern. To be specific, the luminance discrepancy of mixed colors is generated in the case where the gradation level of which representation by combination of subfields is limited in order to reduce the effects of the horizontal crosstalk is represented by a method (e.g., dithering or error diffusion) of spatially or temporally mixing other gradation levels than the gradation level.

However, a mere increase in the number of gradation levels covered by the subfield lighting patterns will generate the chromaticity discrepancy or luminance discrepancy which is attributed to the horizontal crosstalk.

The image display apparatus in the fifth embodiment therefore features a capability to reduce the chromaticity discrepancy and the luminance discrepancy by increasing the number of gradation levels covered by the subfield lighting patterns while reducing the effects of the horizontal crosstalk.

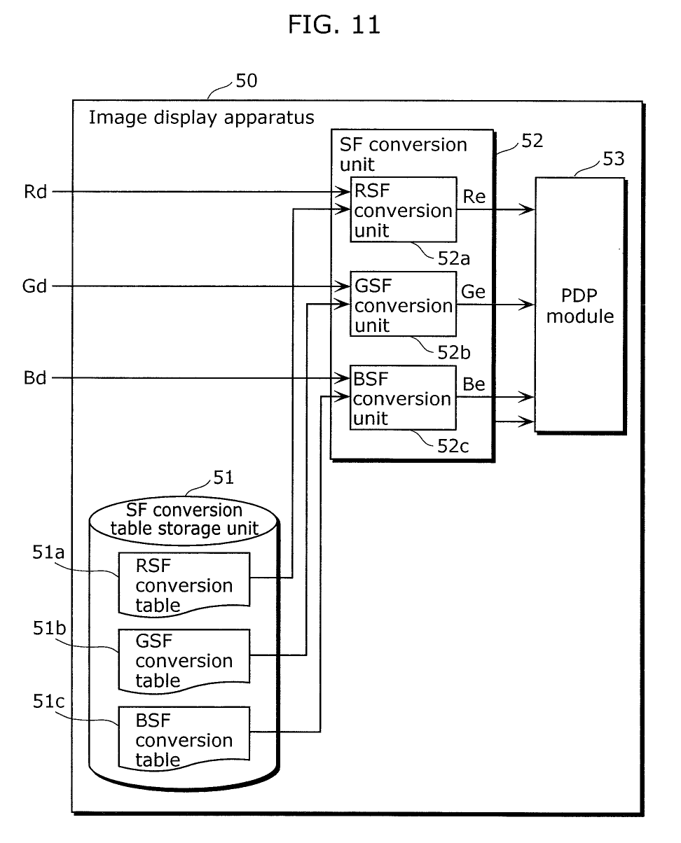

FIG. 11 is a block diagram showing a functional structure of an image display apparatus in the fifth embodiment of the present invention. An image display apparatus 50 includes an SF conversion table storage unit 51, an SF conversion unit 52, and a PDP module 53.

(SF Conversion Table Storage Unit 51)

The SF conversion table storage unit 51 is composed of a nonvolatile memory, for example. In the SF conversion table storage unit 51, an RSF conversion table 51a, a GSF conversion table 51b, and a BSF conversion table 51c, which are SF conversion tables for the respective colors, are stored.

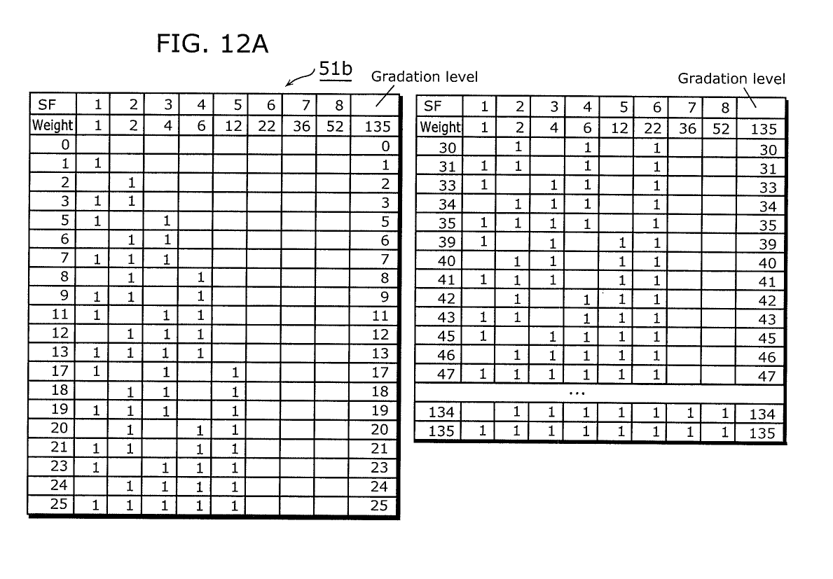

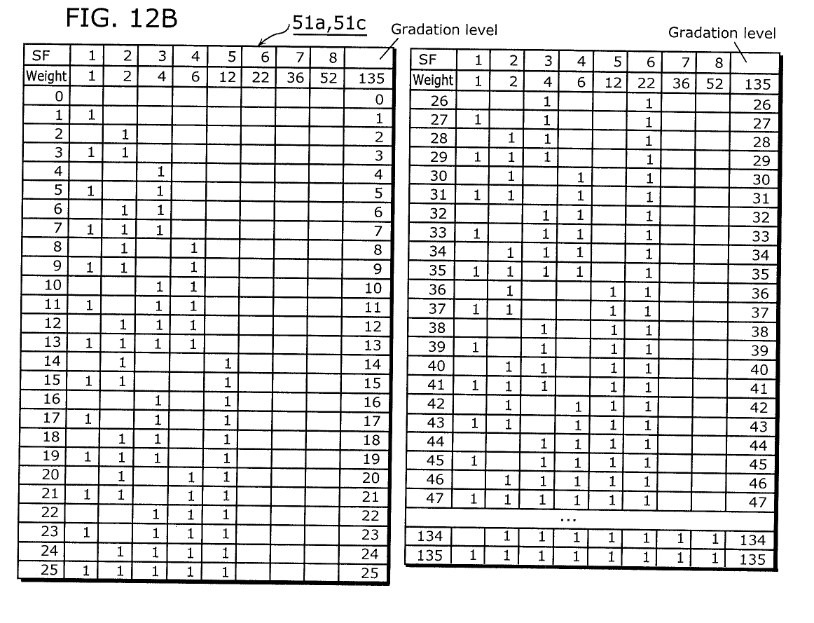

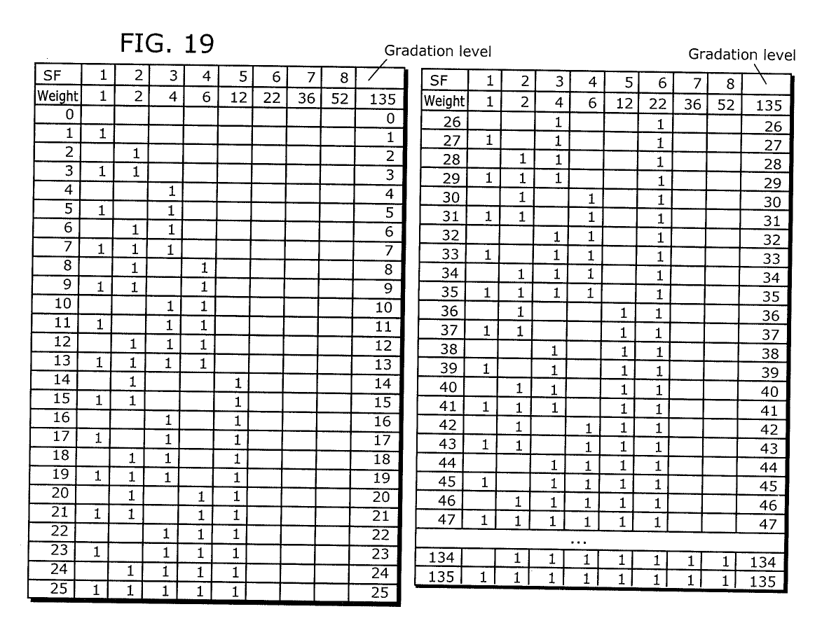

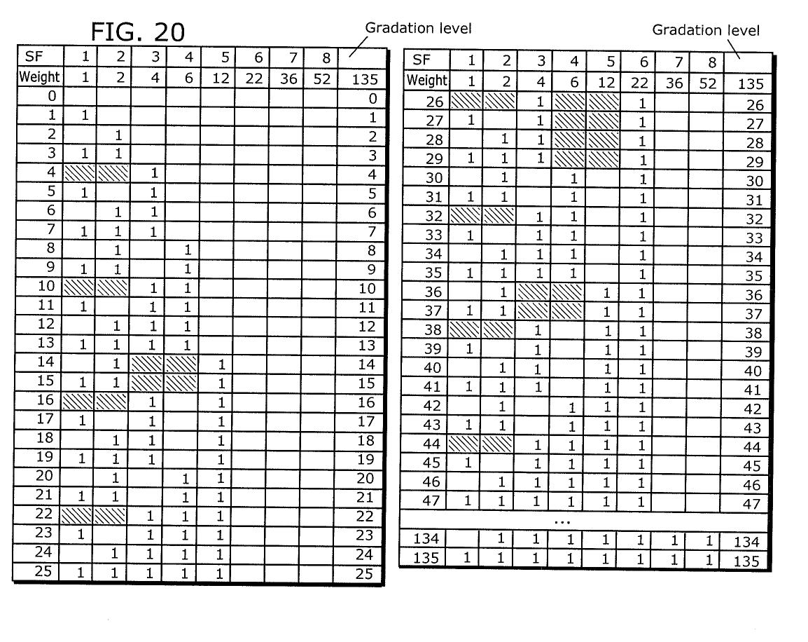

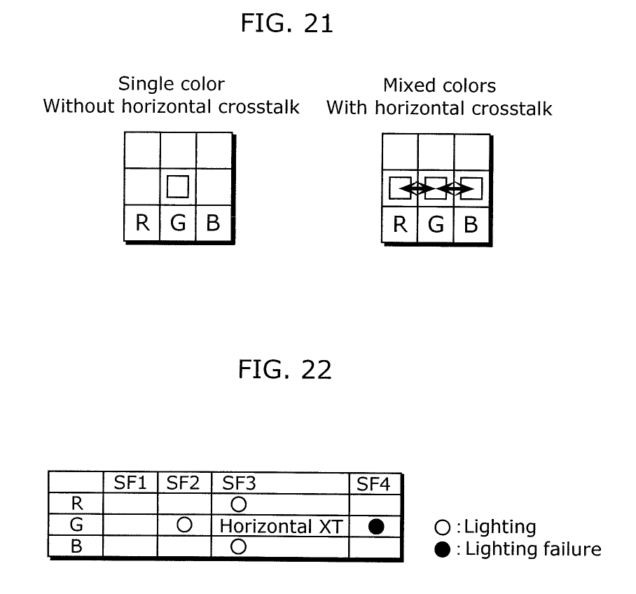

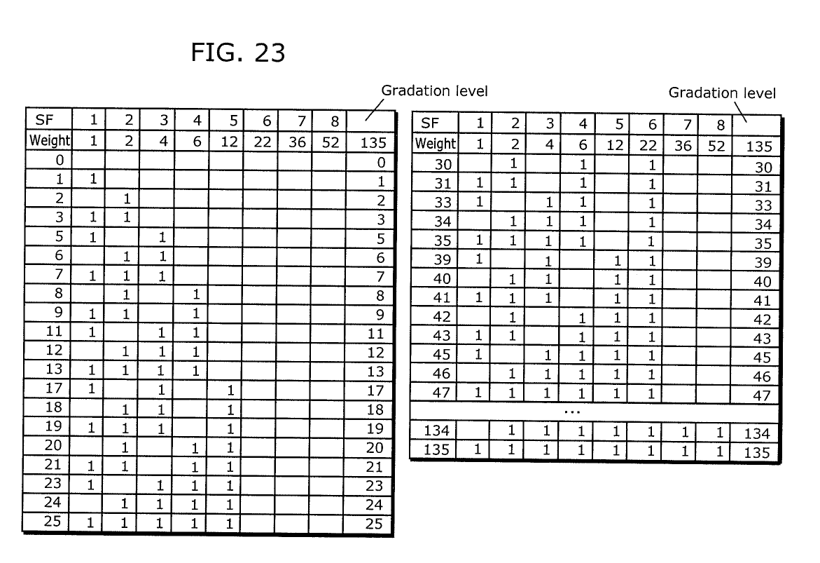

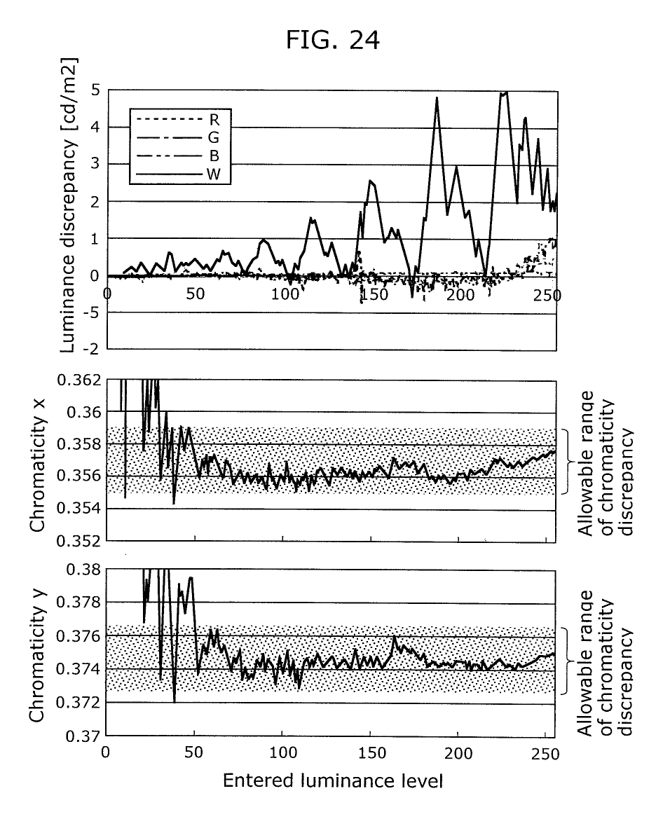

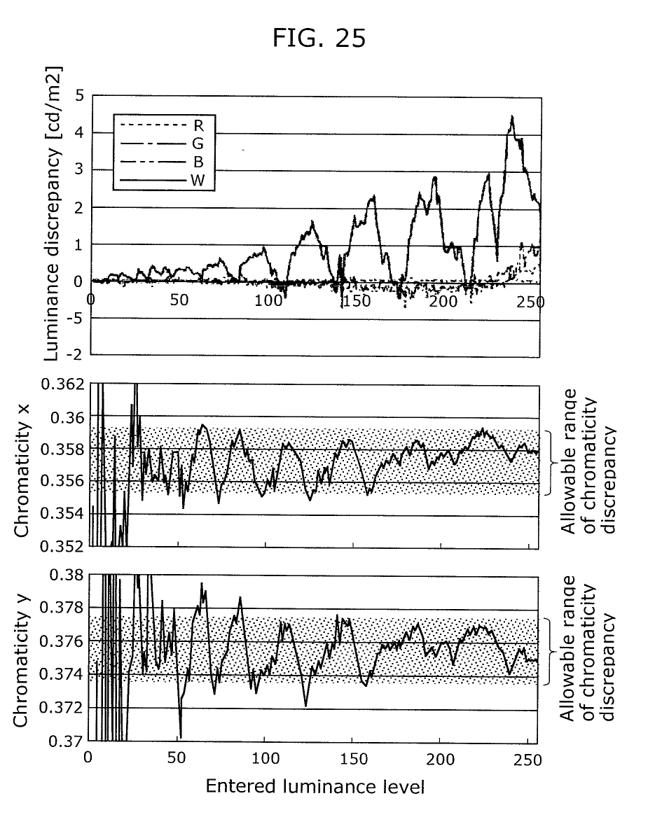

FIG. 12A shows one example of a GSF conversion table 51b. FIG. 12B shows one example of the RSF conversion table 51a or the BSF conversion table 51c. The GSF conversion table 51b shown in FIG. 12A is the same as the SF conversion table of FIG. 23 which is used to avoid the effects of the horizontal crosstalk. The RSF conversion table 51a or BSF conversion table 51c shown in FIG. 12B is the same as the SF conversion table shown in FIG. 19.

This indicates that the number of variations of the lighting pattern presented in the RSF conversion table 51a or the BSF conversion table 51c is larger than the number of variations of the lighting pattern presented in the GSF conversion table 51b. In other words, red or blue, which is less susceptible to the horizontal crosstalk, can be represented in a larger number of gradation levels, using the subfield lighting pattern, than green, which is susceptible to the horizontal crosstalk.

At least either the RSF conversion table 51a or the BSF conversion table 51c needs to be the table shown in FIG. 12B. In other words, at least either the number of variations of the lighting pattern stored in the RSF conversion table 51a or the number of variations of the lighting pattern stored in the BSF conversion table 51c needs to be larger than the number of variations of the lighting pattern stored in the GSF conversion table 51b. Even in this case, the number of variations of the lighting pattern, i.e., the number of representable gradation levels can be larger than the conventional one. Thus, the image display apparatus is capable of reducing the chromaticity discrepancy and the luminance discrepancy while reducing the effects of the horizontal crosstalk.

(SF Conversion Unit 52)

The SF conversion unit 52 has an RSF conversion unit 52a, a GSF conversion unit 52b, and a BSF conversion unit 52c. Each of the RSF conversion unit 52a, the GSF conversion unit 52b, and the BSF conversion unit 52c obtains a lighting pattern associated with a luminance indicated by a color signal of each color with reference to the SF conversion table of a corresponding color (the RSF conversion table 51a, the GSF conversion table 51b, and the BSF conversion table 51c). The RSF conversion unit 52a, the GSF conversion unit 52b, and the BSF conversion unit 52c generate respective lighting signals (Re, Ge, Be) according to the obtained lighting patterns. Furthermore, the SF conversion unit 52 generates a reset signal, a write signal, and a sustain signal, etc.

(PDP Module 53)

The PDP module 53 is composed, for example, of a drive circuit for applying a drive waveform to the alternate-current surface discharge panel and the three electrodes thereon shown in FIG. 1, and displays an image by causing luminescent materials to produce luminescence according to the lighting signals generated by the SF conversion unit 52. The PDP module 53 corresponds to the image display unit.

A conventional lighting pattern is common to R, G, and B for each gradation level. This lighting pattern is the one shown in FIG. 23, which aims to avoid the effects of the horizontal crosstalk as described above. The number of representable gradation levels (the number of variations of the lighting pattern) is therefore lower than the number of gradation levels intrinsically-representable in the subfield driving method as shown in FIG. 19.

A discharge cell affected most by the horizontal crosstalk is a discharge cell of G while discharge cells of R and B are not so affected by the horizontal crosstalk. This is because G is high in visibility and therefore becomes visually prominent when a lighting error occurs. Not only the visual aspect but also a phosphor material is relevant. To be specific, G is affected most by the horizontal crosstalk while R and B are not so affected by the horizontal crosstalk. This is because a surface of a phosphor for G is charged to minus (−) and therefore, as compared to the R and B discharge cells, the G discharge cell is more likely to lose the wall charges due to the horizontal crosstalk, and a writing failure is more likely to occur therein.

To deal with the problem, in the SF conversion table storage unit 51 in the present embodiment, stored is an SF conversion table in which the number of variations of the lighting pattern for R and B shown in FIG. 12B is larger than the number of variations of the lighting pattern for G shown in FIG. 12A. This allows the PDP module 53 to display images with the increased number of variations of the lighting pattern for R and B as compared to the conventional one, and thus display images with the increased number of gradation levels representable using the lighting pattern, without using much error diffusion or dithering.

Furthermore, in the SF conversion table storage unit 51, stored is an SF conversion table in which the number of variations of the lighting pattern for G susceptible to the horizontal crosstalk is smaller than the number of gradation levels intrinsically representable by combination of SFs. The image display apparatus 50 is therefore capable of reducing the luminance discrepancy and the chromaticity discrepancy within the margin for the horizontal crosstalk.

As above, in the image display apparatus 50 in the fifth embodiment, the number of variations of the lighting pattern for at least one of blue and red less susceptible to the horizontal crosstalk can be larger than the number of variations of the lighting pattern for green susceptible to the horizontal crosstalk. The image display apparatus 50 is thus capable of increasing the number of representable gradation levels while reducing occurrences of the horizontal crosstalk. This means that the image display apparatus 50 is capable of effectively reducing the luminance discrepancy and the chromaticity discrepancy at the middle gradation level. In addition, with the increased number of gradation levels representable by the lighting patterns, the image display apparatus 50 is capable of reducing the luminance discrepancy and the chromaticity discrepancy of white as well.

It is to be noted that the luminance discrepancy and the chromaticity discrepancy can be reduced further by combination of the image display apparatus 50 in the fifth embodiment and the color signal correction apparatus in the first to fourth embodiments.

The SF conversion table shown in FIGS. 12A and 12B is an example, and the SF conversion table storage unit 51 does not necessarily need to store the same SF conversion table as that shown in FIGS. 12A and 12B. To be specific, the SF conversion table storage unit 51 only needs to store the GSF conversion table in which the number of variations of the lighting pattern is limited in order to reduce the effects of the horizontal crosstalk, and the RSF conversion table and the BSF conversion table, in at least one of which the number of variations of the lighting pattern is larger than that of the GSF conversion table. Even in this case, the image display apparatus 50, in which the number of gradation levels representable by combination of lighting subfields can be increased, is capable of reducing the chromaticity discrepancy and the luminance discrepancy while reducing the effects of the horizontal crosstalk.

### Sixth Embodiment

When a high-definition panel which is prone to the horizontal crosstalk lights up using the SF lighting patterns illustrated in the fifth embodiment, a lighting failure leading to generation of a luminance discrepancy and a chromaticity discrepancy occurs depending on the SF reset method. Thus, the sixth embodiment describes an SF lighting pattern applicable to a high-definition panel.

As a method of driving the PDP, there is a method called a subfield driving method, in which one filed period is divided into multiple subfields and by combination of the lighting subfields, each of the RGB cells represents a gradation level. Each of the subfields has a reset period, a write period, and a sustain period.

The reset has two types; one is an all-cell reset in which reset discharges are produced in all the discharge cells at a time, and the other is a selective reset in which reset discharges are produced in only the discharge cells in which sustain discharges have been produced. The all-cell reset enables all the discharge cells to produce reset discharges for certain, but if the all-cell reset is applied to all the subfields, the black level will become lighter, which reduces contrast of an image. In addition, the all-cell reset takes a longer time to complete a reset than the selective reset, which makes the drive time schedule tight. A typical image display apparatus therefore executes the all-cell reset only once (e.g., only in SF1) in one filed period.

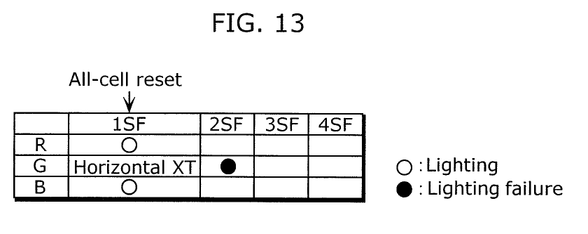

The first addressing discharge (so-called an SF1 addressing discharge) after the aforementioned all-cell reset has a higher discharge intensity than a discharge after the selective reset. Accordingly, in the high-definition panel prone to the horizontal crosstalk, the SF1 addressing discharge causes a lighting failure in SF2 or the following SF, leading to generation of a chromaticity discrepancy. For example, the SF lighting pattern in the fifth embodiment includes the SF lighting pattern as shown in FIG. 13. When the R and B discharge cells among the R, G, and B discharge cells light up in the SF1 as in FIG. 13, the wall charges accumulating in the G discharge cell are deprived by the R and B discharge cells. As a result, in the subsequent SF2, a lighting failure occurs in the G discharge cell. In addition, because of the selective reset in the SF2 and the following SF, the lighting failure in the G discharge cell in the SF2 will result in lighting failures in the SF3 and the following SF.

The image display apparatus in the present embodiment therefore uses SF lighting patterns in which, except when black is displayed, all the SF1s have lighting, that is, the all-cell reset is applied to the SF1s.

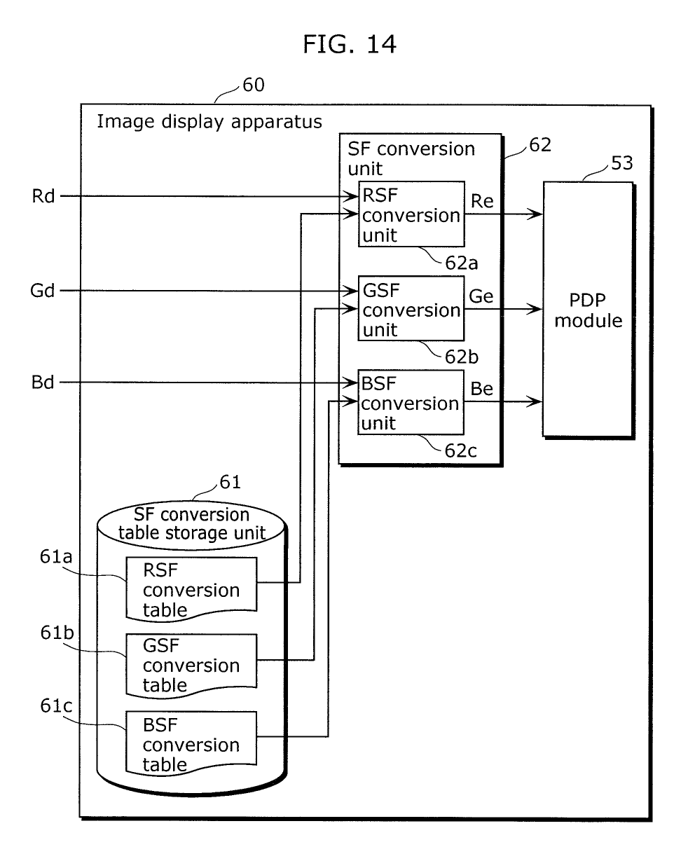

FIG. 14 is a block diagram showing a functional structure of an image display apparatus in the sixth embodiment of the present invention. Elements common to FIG. 11 retain the same numerals in FIG. 14 so that explanation is omitted. An image display apparatus 60 in the present embodiment is different from the image display apparatus 50 in the fifth embodiment in the SF conversion table for each color stored in the SF conversion table storage unit and in part of processing of the SF conversion unit.

### (SF Conversion Table Storage Unit 61)

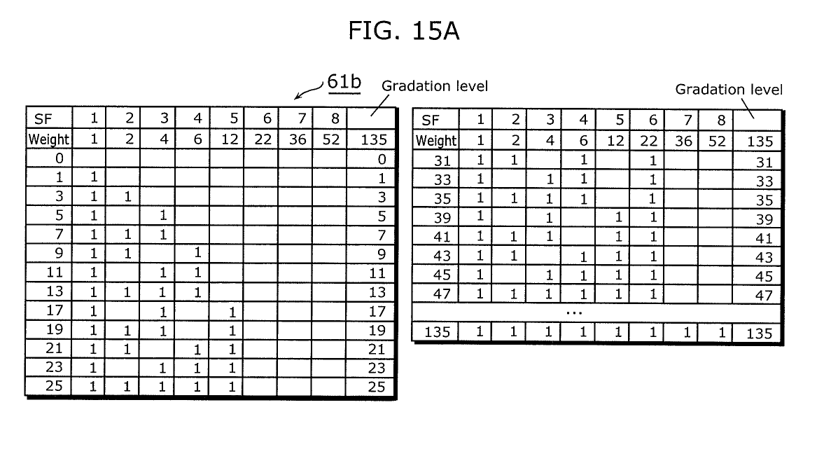

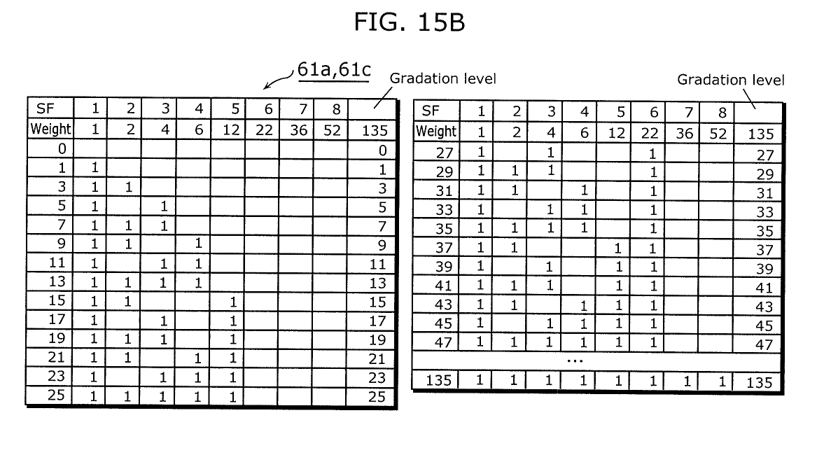

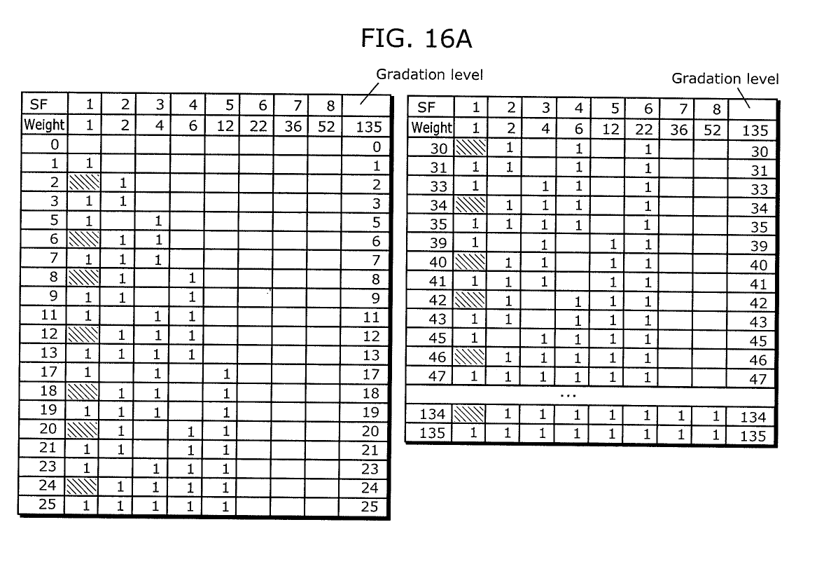

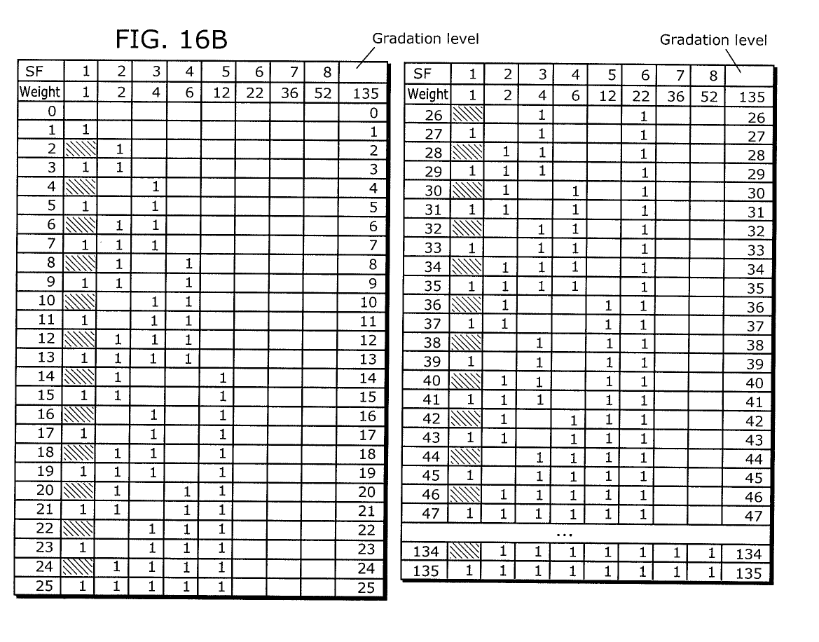

In an SF conversion table storage unit 61, a GSF conversion table 61b, which is shown in FIG. 15A, and an RSF conversion table 61a and a BSF conversion table 61c, which are shown in FIG. 15B, are stored. The GSF conversion table 61b shown in FIG. 15A is an SF conversion table of SF lighting patterns which are obtained by removing SF lighting patterns with non-lighting SF1 (the SF lighting patterns having shaded SF1s in FIG. 16A) from the SF conversion table shown in FIG. 12A. The RSF conversion table 61a and the BSF conversion table 61c shown in FIG. 15B are an SF conversion table of SF lighting patterns which are obtained by removing SF lighting patterns with non-lighting SF1 (the SF lighting patterns having shaded SF1 in FIG. 16B) from the SF conversion table shown in FIG. 12B.

As shown in FIGS. 15A and 15B, the RSF conversion table 61a, the GSF conversion table 61b, and the BSF conversion table 61c store the lighting patterns in which the SF1, as at least one subfield selected from multiple subfields, has lighting, with respect to all the luminance values greater than a predetermined threshold “0”. The predetermined threshold is not always needed to be “0” and may be any value which indicates very low luminance.

Gradation levels taken away by removing the SF lighting patterns containing shaded SFs may be represented by adjustment of weights on sustain pulse numbers and by error diffusion or dithering. To be specific, each of the gradation levels taken away by removing the SF lighting patterns containing shaded SFs may be represented by temporally alternating a higher gradation level and a lower gradation level than that gradation level, for example. Alternatively, each of the gradation levels taken away by removing the SF lighting patterns containing shaded SFs may be represented by spatially alternating a higher gradation level and a lower gradation level than that gradation level, for example. With such a structure, even a high-definition panel is capable of reducing the luminance discrepancy and the chromaticity discrepancy while reducing the effects of the horizontal crosstalk attributed to the all-cell reset.

(SF Conversion Unit 62)

An SF conversion unit 62 obtains a lighting pattern associated with a luminance indicated by a color signal of each color with reference to the SF conversion table. To be specific, each of an RSF conversion unit 62a, a GSF conversion unit 62b, and a BSF conversion unit 62c included in the SF conversion unit 62 obtains a lighting pattern associated with a luminance indicated by a color signal of a corresponding color with reference to the SF conversion table of the corresponding color.

As above, the image display apparatus 60 in the sixth embodiment is capable of lighting the PDP module 53 all the time except when black is displayed, in the subfields susceptible to the horizontal crosstalk. The image display apparatus 60 is thus capable of reducing the luminance discrepancy and the chromaticity discrepancy while reducing the effects of the horizontal crosstalk, even in a high-definition panel susceptible to the horizontal crosstalk. Particularly, the image display apparatus 60 allows a further reduction of the effects of the horizontal crosstalk by lighting the PDP module 53 all the time except when black is displayed, in the subfields which become susceptible to the horizontal crosstalk by the all-cell reset discharge.

Furthermore, not to mention, the image display apparatus 60 is capable of increasing the number of representable gradation levels while reducing the effects of the horizontal crosstalk, and therefore is capable of reducing the luminance discrepancy and chromaticity discrepancy of white.

It is to be noted that the luminance discrepancy and chromaticity discrepancy of white can be reduced further by combination of the image display apparatus 60 in the sixth embodiment and the color signal correction apparatus in one of the first to fourth embodiments.

The SF conversion table shown in FIGS. 15A and 15B is an example, and the SF conversion table storage unit 61 does not necessarily need to store the same SF conversion table as that shown in FIGS. 15A and 15B. To be specific, the SF conversion table storage unit 61 only needs to store an SF conversion table obtained by modifying the SF conversion table in the fifth embodiment so that at least one selected subfield has lighting. Even in this case, upon displaying an image, the image display apparatus 60 in the sixth embodiment is capable of reducing the effects of the horizontal crosstalk further than the image display apparatus 50 in the fifth embodiment.

While the color signal correction apparatus and the image display apparatus in one aspect of the present invention have been described above based on the embodiments, the present invention is not limited to these embodiments. The scope of the present invention includes other embodiments that are obtained by making various modifications that those skilled in the art could think of, to the present embodiments, or by combining constituents in different embodiments.

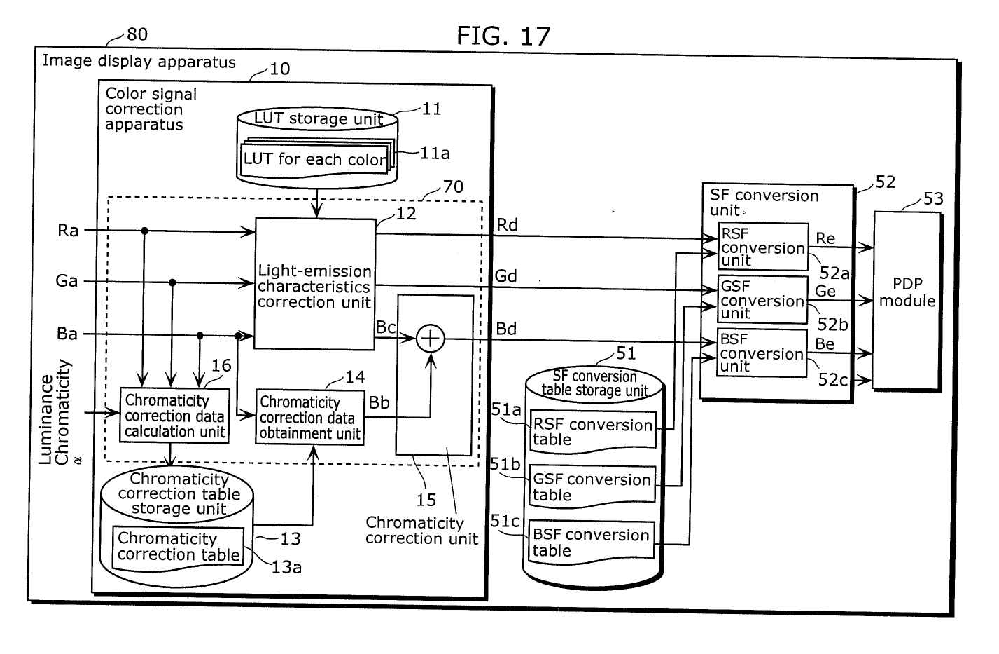

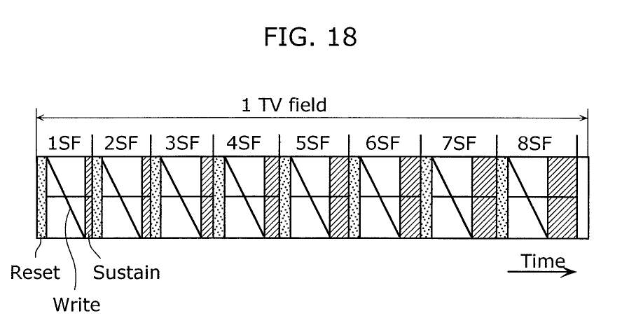

For example, the image display apparatus in the fifth or sixth embodiment may be provided with the color signal correction apparatus in one of the first to fourth embodiments. In the case where the image display apparatus 50 in the fifth embodiment includes the color signal correction apparatus 10 in the first embodiment, for example, the image display apparatus has a structure shown in FIG. 17. In FIG. 17, elements having the same functions as those shown in FIG. 2 or FIG. 11 retain the same numerals.

An image display apparatus 80 includes the color signal correction apparatus 10, an SF conversion table storage unit 51, an SF conversion unit 52, and a PDP module 53. The SF conversion unit 52 obtains a slighting pattern associated with a color signal of each color corrected by the color signal correction apparatus 10. This enables the image display apparatus 80 to provide the effects of both the first embodiment and the fifth embodiment and moreover to reduce occurrences of the luminance discrepancy and the chromaticity discrepancy. Not to mention, a combination of the other embodiments (a combination of one of the first to fourth embodiments with the fifth or sixth embodiment) also has the same effects as above.

Furthermore, although the color signal which is corrected by the chromaticity correction unit in the first or second embodiment is a blue color signal, a red color signal may be corrected instead. This enables an effective reduction of the chromaticity discrepancy and the luminance discrepancy upon displaying white having a color temperature of 9,000K or more, for example.

Furthermore, part or all of the elements included in the above color signal correction apparatus may be provided in one system LSI (large scale integration). The system LSI is a super multifunctional LSI manufactured by integrating multiple components into one chip and is specifically a computer system which includes a microprocessor, a read only memory (ROM), a random access memory (RAM) and so on. For example, as shown in FIG. 2, the light-emission characteristics correction unit 12, the chromaticity correction data obtainment unit 14, the chromaticity correction unit 15, and the chromaticity correction data calculation unit 16 may be provided in one system LSI 70. Furthermore, as shown in FIG. 7, the light-emission characteristics correction unit 12, the chromaticity correction data obtainment unit 14, the chromaticity correction data calculation unit 16, the chromaticity correction switch unit 21, and the chromaticity correction unit 22 may be provided in one system LSI 71. Likewise, as shown in FIG. 9 or FIG. 10, part of the elements included in the color signal correction apparatus may be provided in one system LSI 72 or system LSI 73.

### INDUSTRIAL APPLICABILITY

The present invention is useful for plasma displays capable of reducing at least one of a chromaticity discrepancy and a luminance discrepancy with respect to an input color signal when displaying an image by causing multiple pixels each including phosphors of red, green, and blue to produce luminescence using a subfield driving method. In particular, the present invention is useful for plasma displays that are used as professional devices (such as master monitors and post-production monitors).

### REFERENCE SIGNS LIST

10, 20, 30, 40 Color signal correction apparatus

11 LUT storage unit

11a LUT for each color

12 Light-emission characteristics correction unit

13 Chromaticity correction table storage unit

13a, 13b Chromaticity correction table

14, 32 Chromaticity correction data obtainment unit

15, 22, 33, 42 Chromaticity correction unit

16, 31 Chromaticity correction data calculation unit

21, 41 Chromaticity correction switch unit

50, 60, 80 Image display apparatus

51, 61 SF conversion table storage unit

51a, 61a RSF conversion table

51b, 61b GSF conversion table

51c, 61c BSF conversion table

52, 62 SF conversion unit

52a, 62a RSF conversion unit

52b, 62b GSF conversion unit

52c, 62c BSF conversion unit

53 PDP module

70 System LSI

1. An image display apparatus that displays an image by causing pixels to produce luminescence according to color signals of red, green, and blue colors using a subfield driving method, the pixels each including luminescent materials of red, green, and blue colors, said image display apparatus comprising:
an SF conversion table storage unit configured to store, for each of the colors, an SF conversion table in which a lighting pattern indicating which subfield requires lighting among subfields is stored in association with a luminance indicated by a color signal of each of red, green, and blue colors;
an SF conversion unit configured to (i) obtain the lighting pattern associated with the luminance indicated by the input color signal of each of the colors, with reference to the SF conversion table for each of the colors stored in said SF conversion table storage unit, and (ii) generate, for each of the colors, a lighting signal according to the obtained lighting pattern; and
an image display unit configured to display the image by causing the luminescent materials to produce luminescence according to the lighting signal generated by said SF conversion unit,
wherein the number of variations of the lighting pattern stored in at least one of the SF conversion table for blue and the SF conversion table for red is larger than the number of variations of the lighting pattern stored in the SF conversion table for green.

2. The image display apparatus according to claim 1,
wherein the lighting pattern is stored in the SF conversion table, the lighting pattern indicating lighting in at least one subfield selected from among the subfields, with respect to all luminances above a predetermined threshold.

3. The image display apparatus according to claim 1,
wherein said image display unit includes:
a front substrate having a display electrode including a scanning electrode and a sustain electrode; and
a rear substrate having a data electrode and facing said front substrate so that said data electrode intersects with said display electrode,
discharge cells are formed between said front substrate and said rear substrate which face each other,
in the subfield driving method, 1 TV field is composed of the subfields each having: a reset period in which a reset discharge is produced in at least one of said discharge cells; a write period in which an addressing discharge is produced in a discharge cell to be lighted among said discharge cells; and a sustain period in which a sustaining discharge is produced in said discharge cell in which the addressing discharge has been produced,
at least one of the subfields has an all-cell reset discharge period in which all of said discharge cells produce reset discharges, and
in said SF conversion table, the lighting pattern is stored which indicates lighting in a subfield which is included in the subfields and has the all-cell reset discharge period, with respect to all luminances above a predetermined threshold.

4. The image display apparatus according to claim 1, further comprising:
an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color;
a chromaticity correction table storage unit configured to store a chromaticity correction table in which chromaticity correction data for correcting the color signal of at least one of the blue and red colors is stored in association with the luminance indicated by the input color signal of the corresponding color;
a light-emission characteristics correction unit configured to (i) obtain the light-emission luminance characteristics correction data associated with the luminance indicated by the input color signal of each of the colors, with reference to the LUT for each of the colors, and (ii) correct the input color signal of each of the colors using the obtained light-emission luminance characteristics correction data;
a chromaticity correction data obtainment unit configured to obtain chromaticity correction data associated with the input color signal of at least one of the blue and red colors, with reference to the chromaticity correction table stored in said chromaticity correction table storage unit; and
a chromaticity correction unit configured to correct, using the chromaticity correction data obtained by said chromaticity correction data obtainment unit, the color signal of a color associated with the chromaticity correction data among the color signals of the respective colors corrected by said light-emission characteristics correction unit,
wherein said SF conversion unit is configured to obtain the lighting pattern associated with a luminance of the color signal corrected by said chromaticity correction unit.

5. The image display apparatus according to claim 4, further comprising
a chromaticity correction data calculation unit configured to, when a pixel color specified by the input color signals of the respective colors is white, (i) calculate chromaticity correction data of at least one of the blue and red colors based on a difference between a display chromaticity and a target chromaticity, the display chromaticity being a pixel chromaticity represented on said image display unit according to the color signals obtained by correcting the input color signals of the respective colors with reference to the LUT for each of the colors, and the target chromaticity being a pixel chromaticity specified by the input color signals of the respective colors, and (ii) store the calculated chromaticity correction data into the chromaticity correction table.

6. The image display apparatus according to claim 5,
wherein said chromaticity correction data calculation unit is configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number),
said chromaticity correction data obtainment unit is configured to obtain the chromaticity correction data associated with the luminance indicated by the blue input color signal, with reference to the chromaticity correction table, and
said chromaticity correction unit is configured to correct the blue color signal corrected by said light-emission characteristics correction unit, using the chromaticity correction data obtained by said chromaticity correction data obtainment unit.

7. The image display apparatus according to claim 5,
wherein said chromaticity correction data calculation unit is configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number),
said chromaticity correction data obtainment unit is configured to obtain the chromaticity correction data associated with the luminance indicated by the red input color signal, with reference to the chromaticity correction table, and
said chromaticity correction unit is configured to correct the red color signal corrected by said light-emission characteristics correction unit, using the chromaticity correction data obtained by said chromaticity correction data obtainment unit.

8. The image display apparatus according to claim 5,
wherein said chromaticity correction data calculation unit is configured to (i) decompose a vector into vectors in directions of two line segments, the vector being obtained by multiplying a chromaticity reduction vector heading for xy coordinates of the target chromaticity from xy coordinates of the measured display chromaticity by a luminance level of white indicated by the target chromaticity and by a predetermined coefficient α (where α is a positive real number), and the two line segments being a line segment linking the xy coordinates of the target chromaticity and xy coordinates indicating the chromaticity of blue and a line segment linking the xy coordinates of the target chromaticity and xy coordinates indicating the chromaticity of red, and (ii) calculate magnitudes of the vectors resulting from the vector decomposition, as the chromaticity correction data of the blue and red colors,
said chromaticity correction data obtainment unit is configured to obtain the chromaticity correction data associated with the luminance indicated by the input color signals of the blue and red colors, with reference to the chromaticity correction table, and
said chromaticity correction unit is configured to correct the input signals of the blue and red colors corrected by said light-emission characteristics correction unit, using the chromaticity correction data obtained by said chromaticity correction data obtainment unit.

9. The image display apparatus according to claim 6,
wherein the predetermined coefficient α is a predetermined value of 100 or less.

10. The image display apparatus according to claim 4,
wherein said chromaticity correction unit is configured to correct the color signal when luminance levels indicated by the input color signals of the respective colors are substantially same.

11. The image display apparatus according to claim 4,
wherein said chromaticity correction unit is configured to correct the color signal using a value obtained by multiplying the chromaticity correction data by a predetermined coefficient β (where β is a real number from 0 to 1 inclusive) which gradually increases as time passes from when the luminance levels indicated by the input color signals of the respective colors become substantially same.

12. A color signal correction apparatus that corrects color signals of red, green, and blue colors, which are provided to an image display unit that displays an image by causing pixels to produce luminescence using a subfield driving method, the pixels each including luminescent materials of red, green, and blue colors, said color signal correction apparatus comprising:
an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color;
a chromaticity correction table storage unit configured to store a chromaticity correction table for storing chromaticity correction data for correcting the color signal of at least one of the blue and red colors, in association with a luminance indicated by the input color signal of the corresponding color;
a chromaticity correction data calculation unit configured to, when a pixel color specified by the input color signals of red, green, and blue colors is white, (i) calculate chromaticity correction data of at least one of the blue and red colors based on a difference between a display chromaticity and a target chromaticity, the display chromaticity being a pixel chromaticity represented on said image display unit according to the color signals obtained by correcting the input color signals of the respective colors with reference to the LUT for each of the colors, and the target chromaticity being a pixel chromaticity specified by the input color signals of the respective colors, and (ii) store the calculated chromaticity correction data into the chromaticity correction table;
a light-emission characteristics correction unit configured to (i) obtain the light-emission luminance characteristics correction data associated with the luminance indicated by the input color signal of each of the red, green, and blue colors, with reference to the LUT for each of the colors, and (ii) correct the input color signal of each of the colors using the obtained light-emission luminance characteristics correction data;
a chromaticity correction data obtainment unit configured to obtain chromaticity correction data associated with the input color signal of at least one of the blue and red colors, with reference to the chromaticity correction table stored in said chromaticity correction table storage unit; and
a chromaticity correction unit configured to correct, using the chromaticity correction data obtained by said chromaticity correction data obtainment unit, the color signal of a color associated with the chromaticity correction data among the color signals of the respective colors corrected by said light-emission characteristics correction unit.

13. The color signal correction apparatus according to claim 12,
wherein said chromaticity correction data calculation unit is configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number),
said chromaticity correction data obtainment unit is configured to obtain the chromaticity correction data associated with the luminance indicated by the blue input color signal, with reference to the chromaticity correction table, and
said chromaticity correction unit is configured to correct the blue color signal corrected by said light-emission characteristics correction unit, using the chromaticity correction data obtained by said chromaticity correction data obtainment unit.

14. The color signal correction apparatus according to claim 12,
wherein said chromaticity correction data calculation unit is configured to calculate the chromaticity correction data by (i) multiplying a difference value between a y-coordinate or x-coordinate of the target chromaticity and a y-coordinate or x-coordinate of the measured display chromaticity, by a luminance level of white indicated by the target chromaticity, and further (ii) multiplying the resultant value by a predetermined coefficient α (where α is a positive real number),
said chromaticity correction data obtainment unit is configured to obtain the chromaticity correction data associated with the luminance indicated by the red input color signal, with reference to the chromaticity correction table, and
said chromaticity correction unit is configured to correct the red color signal corrected by said light-emission characteristics correction unit, using the chromaticity correction data obtained by said chromaticity correction data obtainment unit.

15. The color signal corresponding apparatus according to claim 12,
wherein said chromaticity correction data calculation unit is configured to (i) decompose a vector into vectors in directions of two line segments, the vector being obtained by multiplying a chromaticity reduction vector heading for xy coordinates of the target chromaticity from xy coordinates of the measured display chromaticity by a luminance level of white indicated by the target chromaticity and by a predetermined coefficient α (where α is a positive real number), and the two line segments being a line segment linking the xy coordinates of the target chromaticity and xy coordinates indicating the chromaticity of blue and a line segment linking the xy coordinates of the target chromaticity and xy coordinates indicating the chromaticity of red, and (ii) calculate magnitudes of the vectors resulting from the vector decomposition, as the chromaticity correction data of the blue and red colors,
said chromaticity correction data obtainment unit is configured to obtain the chromaticity correction data associated with the luminance indicated by the input color signals of the blue and red colors, with reference to the chromaticity correction table, and
said chromaticity correction unit is configured to correct the input signals of the blue and red colors corrected by said light-emission characteristics correction unit, using the chromaticity correction data obtained by said chromaticity correction data obtainment unit.

16. The color signal correction apparatus according to claim 13,
wherein the predetermined coefficient α is a predetermined value of 100 or less.

17. The color signal correction apparatus according to claim 12,
wherein said chromaticity correction unit is configured to correct the color signal when luminance levels indicated by the input color signals of the respective colors are substantially same.

18. The color signal correction apparatus according to claim 12,
wherein said chromaticity correction unit is configured to correct the color signal using a value obtained by multiplying the chromaticity correction data by a predetermined coefficient β (where β is a real number from 0 to 1 inclusive) which gradually increases as time passes from when the luminance levels indicated by the input color signals of the respective colors become substantially same.

19. A color signal correction method for use in a color signal correction apparatus that corrects color signals of red, green, and blue colors, which are provided to an image display unit that displays an image by causing pixels to produce luminescence using a subfield driving method, the pixels each including luminescent materials of red, green, and blue colors, the color signal correction apparatus including:
an LUT storage unit configured to store a look-up table (LUT) for each of the red, green, and blue colors, in which light-emission luminance characteristics correction data for correcting light-emission luminance characteristics of the luminescent material for the corresponding color are stored in association with the luminance indicated by the input color signal of the corresponding color; and
a chromaticity correction table storage unit configured to store a chromaticity correction table for storing chromaticity correction data for correcting the color signal of at least one of the blue and red colors, in association with a luminance indicated by the input color signal of the corresponding color,
said color signal correcting method comprising:
calculating, when a pixel color specified by the input color signals of red, green, and blue colors is white, chromaticity correction data of at least one of the blue and red colors based on a difference between a display chromaticity and a target chromaticity, the display chromaticity being a pixel chromaticity represented on the image display unit according to the color signals obtained by correcting the input color signals of the respective colors with reference to the LUT for each of the colors, and the target chromaticity being a pixel chromaticity specified by the input color signals of the respective colors, and then storing the calculated chromaticity correction data into the chromaticity correction table;
correcting light-emission characteristics by obtaining the light-emission luminance characteristics correction data associated with the luminance indicated by the input color signal of each of the red, green, and blue colors, with reference to the LUT for each of the colors, and then correcting the input color signal of each of the colors using the obtained light-emission luminance characteristics correction data;
obtaining chromaticity correction data associated with the input color signal of at least one of the blue and red colors, with reference to the chromaticity correction table stored in the chromaticity correction table storage unit; and
correcting, using the chromaticity correction data obtained in said obtaining, the color signal of a color corresponding to the chromaticity correction data among the color signals of the respective colors corrected in said correcting of light-emission characteristics.
